(19) United States
(12) Patent Application Publication
(10) Pub. No.: US 2018/0173896 A1
(43) Pub. Date: Jun. 21, 2018

(54) PRODUCT DATA INTERFACE THROUGH A PERSONAL ASSISTANCE SOFTWARE AGENT USING RANDOM NUMBER IDENTIFIERS (RNIDs)

(71) Applicant: Matrics2, Inc., Warba, MN (US)

(72) Inventors: Michael R. Arneson, Warba, MN (US); William R. Bandy, Gambrills, MD (US); Randolph J. Stimac, Grand Rapids, MN (US)

(21) Appl. No.: 15/843,806

(22) Filed: Dec. 15, 2017

Related U.S. Application Data
(60) Provisional application No. 62/434,807, filed on Dec. 15, 2016.

(51) Int. Cl. G06F 21/62; G06F 21/44; G06K 19/07; G06Q 30/02; G06Q 30/06

(52) U.S. Cl. CPC G06F 21/6254; G06F 21/6263; G06Q 30/0627; G06K 19/0723; G06Q 30/0251; G06F 21/44

(57) ABSTRACT

Methods, systems, and apparatuses in a communication system for interfacing data. The method includes receiving a tag identifier and an application identifier from an application at a user device; authenticating the application using the application identifier; determining a manufacturer identifier that corresponds to the tag identifier in an identifier repository; transmitting the application identifier, the tag identifier and the manufacturer identifier to a computing device associated with the manufacturer identifier; receiving the manufacturer item identifier, the tag identifier, the application identifier, and specific item information from the manufacturer computing device; and transmitting the manufacturer item identifier, the tag identifier and the specific item information to the application to enable the specific item information can be displayed on the user device.

### CROSS-REFERENCE TO RELATED APPLICATIONS

This application claims priority to U.S. Provisional Patent Application No. 62/434,807, filed Dec. 15, 2016 and entitled “Item Data Interface Through a Personal Assistance Software Agent using Random Number ID's (RNIDs),” the entirety of which is incorporated by reference herein.

The instant application is related to U.S. patent application Ser. No. 15/374,889 entitled “System and Method for Randomization for Robust RFID Security,” filed Dec. 9, 2016, the entirety of which is incorporated herein by reference.

The instant application is related to U.S. patent application Ser. No. 15/451,063 entitled “System, Apparatus, and Method for Forming a Secured Network Using Tag Devices Having a Random Identification Number Associated Therewith,” filed Mar. 6, 2017, the entirety of which is incorporated herein by reference.

### BACKGROUND

### Technical Field

The present patent application relates to product data interfaced through a personal assistance software agent using random number ID's (RNIDs).

### Description of Related Art

A unique identifier is any identifier which is guaranteed to be unique among all identifiers used for a set of objects and for a specific purpose. Random number generation is the generation of a sequence of numbers or symbols that cannot be reasonably predicted better than by a random chance. Various applications of randomness have led to the development of several different methods for generating random data.

### BRIEF SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program items are provided for identifying and tracking items with random number identifiers, and enabling secure communications regarding the items between an identifier access manager, manufacturers, retailers, and users. The identifier access manager manages and issues the random number identifiers. The identifier access manager may issue RFID tags that contain the random number identifiers as tag identifiers, and may assign random number identifiers to the manufacturers, retailers, and personal assistance applications of the users. A manufacturer that manufactures items (e.g., products), may be issued a random number manufacturer identifier, and may apply the RFID tags to their items. A retailer may be issued a random number retailer identifier, and may offer the manufacturer's tagged items for sale. A personal assistance application may be downloaded to a user's computing device, may be issued a random number application identifier, and may enable and assist the user in researching and purchasing the tagged items. The identifier access manager may be implemented in a server (“identifier server”) through which communications between the identifier access manager, manufacturer, retailer, and personal assistance application pass, using the random number identifiers for tracking purposes and to maintain privacy.

In one example aspect, an identifier server includes an identifier access manager configured to receive a tag identifier and an application identifier from an application at a user device. The tag identifier is associated with a RFID tag associated with an item of a plurality of items. The application identifier is associated with the application. The identifier access manager is configured to authenticate the application using the application identifier, determine a manufacturer identifier that corresponds to the tag identifier, and transmit the application identifier, the tag identifier, and the manufacturer identifier to a manufacturer server associated with the manufacturer identifier. The identifier access manager is further configured to receive the manufacturer item identifier, the tag identifier, the application identifier and specific item information from the manufacturer server and transmit the manufacturer item identifier, the tag identifier and the specific item information to the application to enable the specific item information to be displayed on the user device.

Further features and advantages of the invention, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for interfacing item information while maintaining user privacy using RNID tags, according to an example embodiment.

FIGS. 2A-2C show flowcharts for interfacing item information while maintaining user privacy using RNID tags, according to an example embodiment.

FIG. 3 shows a block diagram of an identifier server, according to an example embodiment.

FIGS. 4A-4E show block diagrams of systems for interfacing item and advertisement information while maintaining user privacy, illustrating interactions between an application, an identifier server, a manufacturer item database, and a personal database, according to example embodiments.

FIG. 5 shows a block diagram of a system for obtaining information using data mining, according to example embodiments.

FIG. 6 shows a block diagram of a hierarchy of RNID tags, according to example embodiments.

FIG. 7 shows a flowchart for assigning random identifiers to a plurality of items, according to an example embodiment.

FIG. 8 shows a flowchart for transmitting one or more targeted coupons to a user, according to an example embodiment.

FIG. 9 shows another flowchart for transmitting one or more targeted coupons to a user, according to an example embodiment.

FIG. 10 shows a flowchart for enabling the download of application software, according to an example embodiment.

FIG. 11 shows another block diagram of a system for interfacing item information while maintaining user privacy using RNID tags, according to example embodiments.

FIG. 12 is a block diagram of a computing device/system in which the techniques disclosed herein may be performed and the example embodiments herein may be utilized.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

When a consumer or user is viewing or purchasing an item online, the consumer may unknowingly communicate private personal data to the providers or entities (e.g., retailers or manufacturers). This private personal data may include user browsing histories, mobile location data and other information generated by the user while using the Internet. Accordingly, providers may use this private personal data to their advantage for targeted advertising or selling it to third-parties, thus, infringing the privacy of the user. However, the FCC has proclaimed, in the FCC 16-39 Notice of Proposed Rulemaking (NPRM), released Apr. 1, 2016, and approved by the FCC (Federal Communications Commission) commissioners Oct. 27, 2016, that all consumers must be able to protect their privacy, including the security foundations of data security, transparency, and choice. The first security foundation, “data security,” includes enacting “True Privacy,” which protects every important personal interest. This includes enabling every telecommunications user the ability to protect the user's privacy which includes not only identity and financial information but also intimate, personal details relating the user. The second security foundation, “transparency,” involves that an internet service provider (ISP) must reveal what customer information that they collect and for what purposes, what customer information they share and with what types of entities, and how, and to what extent, customers can opt in or opt out of use and sharing of their personal information. The third security foundation, “choice,” enables a user to opt-in or opt-out of the sharing of their information. As defined by the FCC, the opt-out must be clearly disclosed, easily used, and continuously available. A provider must receive opt-in approval from a user prior to sharing consumer information with non-communications-related affiliates or third parties or before using consumer information themselves for any unapproved purposes. Developing a system that efficiently and concretely upholds all three of these security foundations is costly and difficult to prove, since the system must be checked continuously to ensure the system is working properly.

Embodiments overcome these and other issues related to upholding security foundations by preventing user information from being revealed to non-communications related affiliates or third parties. In embodiments, a system assigns to and maintains a unique random number ID for each entity in the system. An entity may include, for example, each user, database, or item enrolled in a system. For instance, when a user is enrolled in the system, by downloading a software assistance agent (i.e., application software), a unique application random number ID (RNID) (i.e., application identifier) is assigned to the user-downloaded application software and maintained in the central server. In this way, the application identifier represents the user in the system without identifying the user. As such, the application software enables the user to interact within the system in a private manner. In embodiments, the user downloads the application software from the central server. Alternatively, the user downloads the application software from another server.

Furthermore, when a provider is enrolled in the system, the provider (e.g., retailer or manufacturer) is assigned a unique provider RNID (e.g., manufacturer identifier, retailer identifier) that is also maintained in the central server along with a corresponding link address, or pointer, such as a URL. In this way, the provider is represented in the system by the unique RNID without identifying the provider, and the corresponding link address or pointer enables the central server to interact with the corresponding provider database at the provider computing device.

Still further, each item enrolled in the system is assigned a unique tag RNID (i.e., tag identifier) and at least one unique item provider RNID (e g, manufacturer item identifier, retailer item identifier) that corresponds to the associated provider RNID. The identifiers are all stored in the central server and related, as applicable. The tag identifier is also stored in an RFID tag in or on the item and is scannable, such that, the tag identifier may be transmitted to the central database such that the item provider RNID may be determined. Furthermore, the item provider RNIDs are also stored in the associated provider database with the specific item information that corresponds to the item. In this way, once the central server determines the item provider RNID, the associated provider RNID is obtained along with the link address. Accordingly, the central server may obtain the specific item information that corresponds to the item provider RNID. Thus, a user may securely access specific item information of a scanned item by using RNIDs.

Accordingly, in embodiments, the user is enabled to interact within the system in a secure manner as both their private information and interaction history is private within the central server as a series of RNIDs. The only way a provider can communicate with a user is based on prior interactions with that provider and via the application. For instance, if the user retrieves specific item information from a manufacturer, only that specific manufacturer knows what the user retrieved and the user's application identifier. In this way, no private user information is ever disclosed to any entity in the system because the private information is not maintained or sent through the system, only the application identifier. Even the viewing history of a user and a provider is private to those external providers because without knowing the RNID an external provider cannot know anything.

In embodiments, the application software further enables the creation of a personal database, that is stored in the system. The user is enabled to accept or decline the creation of the personal database when the application software is downloaded. If the personal database is created in the system, the personal database is also assigned a unique RNID (i.e., personal database identifier) that is stored in the central server. As the user requests item information or purchases an item, the associated information is stored within the personal database. As such, through the personal database, the user is enabled to interact with the wanted or purchased items in the personal database and obtain additional information relating to the items. For instance, the user may ask how to cook a turkey that was purchased or when the milk they purchased will expire. In further embodiments, the personal database, under the direction of the application software, can “data mine” or obtain additional data regarding the items in the personal database. This “mined data” may be used by the user at a later time.

In an embodiment, a communication system includes an identifier server that acts as the secure central server and includes an identifier access manager configured to interface information between a user and external databases while maintaining privacy. The external databases may include, for instance, a personal database, a manufacturer item database and a retail database. The identifier server further includes an identifier assignor configured to assign unique RNIDs to each entity in the system. For instance, when a user downloads application software, the identifier assignor is configured to assign an application identifier to the application software. In an embodiment, the application software is downloaded from application software storage of the identifier server. Alternatively, the application software is downloaded from another server. Additionally, if during the application software download the user opts in to creating a personal database, the identifier assignor is configured to assign a personal database identifier to the personal database associated with the application software. In an embodiment, the identifier server further includes an identifier repository, configured to store any assigned identifiers.

Furthermore, the identifier assignor is configured to assign unique provider RNIDs to each database in the system such that the assigned provider RNIDs are also stored in the identifier repository in place of detailed identifying information (e.g., retailer name, manufacturer name, etc.). Still further, the identifier assignor is configured to assign tag identifiers to each item in the system as well as unique item provider RNIDs (e.g., manufacturer item identifier, retailer item identifier), when applicable. These identifiers are stored associated in the identifier repository such that the identifier access manager is enabled to determine the relationships between the identifiers in a secure manner. The identifiers are also stored in the associated provider database along with the specific item information. In this way, when a user wants to access specific item information relating to an item, the identifier access manager is enabled to obtain the specific item information without knowing the actual item name or the private user information. In other words, the identifier access manager is enabled to receive merely the tag identifier of the item, determine the manufacturer item identifier associated with the tag identifier, obtain the manufacturer identifier associated with the manufacturer item identifier and obtain the specific item information from the manufacturer database associated with the manufacturer identifier. The identifier access manager is completely unconcerned with any specific information and merely relies on the stored random IDs. Accordingly, the identifier access manager maintains complete privacy between the user and external databases in a very different manger from conventional techniques.

In embodiments, the RNIDs are randomly generated and may include, for instance, greater than or equal to 64 bits, and may be hard-coded, such as through laser programming, into an integrated circuit read-only memory (ROM). However, it should be understood that the IDs may include less than 64 bits. The chips are assembled onto various preprinted antenna substrates to item RNID NFC tag entities. The chip could be attached to any substrate that has a printed, etched or other manufacturing techniques used to produce antennas which are then singulated to provide for individual tag labels that are attached to finished packaging or item. The chips could also be attached to any stock materials that could be used for source tagging, such as the stock used to form boxes or wrappings for item, that has the antenna integral to that substrate. In short, the definition of a tag entity is either a tag label or a source tag incorporated in the item or item packaging material. Hereinafter, such tag entities will just be referred to as tags, but the term can refer to any of the tag entity definitions.

In an embodiment, label tags may be sold to manufactures, retailers, or other tag customers who may attach them to their items. Source tags may be attached with the packaging source stock, so they become associated with item when the item is packaged. In either case, the tags are associated with the item. As noted above, when they are so associated, they are stored in the corresponding item database (i e, manufacturer item database, retailer's item database, etc.) where the RNIDs are associated with item information, such as barcodes, or any other information for the items they are attached to. Random ID Symbols (RIDS), could also be used in the same way as with RNIDs for uniquely identifying item and interacting with item information.

Tagged items are any objects that are desired to have a unique random number identification, as well as unique data associated with the item, as opposed to the conventional identification of a class of item with a barcode. For instance, in conventional techniques one box of cereal is the same as another, each with the same barcode. Embodiments described herein, including the RNID NFC tag included in the application software, provide uniqueness at the individual item level, so now each box of cereal has its own ID number, as well as the barcode identifier. In embodiments, item encompasses anything that can be produced, such as, home automation systems, entertainment, home security, smart appliances, sensors, automobiles, etc.

As noted above, once generated and programmed for a specific manufacturer, retailer, or any other provider, the resulting provider item identifiers are stored in the central server, where each-and-every provider item identifier is associated with a provider identifier that is assigned to every provider. When a smart phone reader (SPR) is placed into close-proximity of the RNID NFC tag, the SPR reads the tag, obtaining its tag identifier, which is then sent over the cellular network by the SPR to the central server which retrieves the provider item identifier and obtains the associated provider identifier. The provider item identifier and the provider identifier is used as authentication to access the provider database for the specific item information associated with the provider item identifier, which is then sent back to the SPR through the central server for display on its screen.

This approach has numerous advantages, including maintaining complete user privacy even when the user makes an item purchase or makes an inquiry about an item or coupons. Furthermore, a provider is enabled to enact targeted advertising to a user that had previously inquired or purchased an item or related item. By using this approach, the provider is targeting a user that has a high likelihood of purchasing the item or a related item and is maintaining privacy as required by the FCC. Still further, the personal database of a user may be called upon by a user to access any information associated with a purchased or desired item. In this way, the user easily maintains a database of items and related information that is helpful to the user. For instance, the database may alert the user when the user is out of an item or an item has expired.

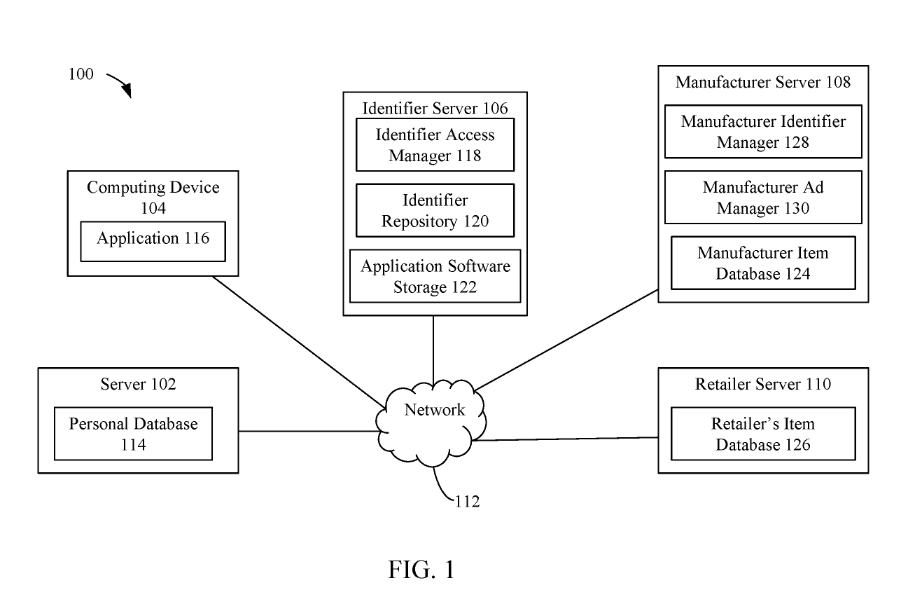

Example embodiments are described as follows that are directed to techniques for interfacing item information in a communication system. For instance, FIG. 1 shows a block diagram of a system 100 for interfacing item information while maintaining user privacy using RNID tags, according to an example embodiment. As shown in FIG. 1, system 100 includes a personal data server 102, a computing device 104, an identifier server 106, a manufacturer server 108, and a retailer server 110 which are all communicatively coupled via network 112. Each of personal data server 102, computing device 104, identifier server 106, manufacturer server 108, and retailer server 110 may include at least one network interface that enables communications over network 112. Network 112 may comprise one or more networks such as local area networks (LANs), wide area networks (WANs), enterprise networks, the Internet, etc., and may include one or more of wired and/or wireless communication links. Identifier server 106 includes an identifier access manger 118, an identifier repository 120, and an application software storage 122. Personal data server 102 includes a personal database 114. Computing device 104 includes an application 116. Manufacturer server 108 includes a manufacturer item database 122, a manufacturer identifier manager 128, and a manufacturer advertisement manager 130. Retailer server 110 includes a retailer's item database 124. These and further features of FIG. 1 are described as follows.

Computing device 104 may be any type of stationary or mobile computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google® Android™ operating system, a Palm® device, a Blackberry® device, etc.), a wearable computing device (e.g., a smart watch, a head-mounted device including smart glasses such as Google® Glass™ etc.), or other type of mobile device (e.g., an automobile), or a stationary computing device such as a desktop computer or PC (personal computer), a portable media player, a stationary or handheld gaming console, a personal navigation assistant, a camera, or other type or stationary or mobile device, a web server or a collection of servers that are accessible over network 112 (e.g., “network-based” or “cloud-based” servers in an embodiment) to store, manage, and process data. Each of personal data server 102, identifier server 106, manufacturer server 108, and retailer server 110 may be formed of one or more computing devices that enable communications between devices and/or that are capable of serving information and/or providing other services. Each of personal data server 102, identifier server 106, manufacturer server 108, and retailer server 110 may include any number of individual server devices, including tens, hundreds, and thousands of servers.

Although only one of each of personal data server 102, computing device 104, manufacturer server 108, and retailer server 110 is shown in FIG. 1, in other embodiments, other numbers of personal data server 102, computing device 104, manufacturer server 108, and retailer server 110 may be present in system 100, including tens, hundreds, thousands, and greater numbers.

Application 116 in computing device 104 is an instance of an application (e.g., implemented in computer code executed by a processor, programmed according to any suitable programming language and/or scripting language, such as C++, C#, HTML (hypertext markup language), JavaScript, etc.) configured to obtain information from manufacturer item database 124 and retailer's item database 126 via identifier access manager 118, and to provide a user interface for a user at the corresponding device. Application 116 is further configured to transmit and obtain information from personal database 114 of personal data server 102, discussed in detail hereinafter. In embodiments, application 116 may be any type of application capable of obtaining and displaying item information, as well as enabling a user to use functionality of computing device 104 to interact with items, such as by reading RFID tags, scanning barcodes or other item identifiers, etc., and enables communications with manufacturers and retailers through identifier server 106 via the use of random identifiers managed by identifier access manager 118. In an embodiment, application 116 may be or contain a personal assistant software (PAS) agent (referred to herein as “PAS”), also known as a virtual assistant, that enables these capabilities, along with additional intelligent functions described elsewhere herein.

In embodiments, application 116 may be downloaded directly from identifier server 106. For instance, and as shown in FIG. 1, identifier server 106 includes an application software storage 122. Application software storage 122 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium. Application software storage 122 may store application 116 and optionally further information. A user of computing device 104 may download application 116 from application software storage 122. When downloaded, application 116 is assigned its own unique random number ID (i.e., application identifier) by identifier access manager 118 that is stored in identifier server 106, described in detail hereinafter. The random number application identifier is not associated at identifier server 106 or elsewhere with identifying information of the user. The random number identifier is used by application 116 in communications with other entities in lieu of identifying information of the user, thereby maintaining privacy for the user of application 116, because entities do not receive personal/identifying information of the user, but instead receive the random number application identifier of application 116, which the entities cannot connect to the user's identity. In an embodiment, identifier access manager 118 maintains the random number identifier for application 116 in association with a communication link/address for application 116, and thus is the conduit for communications with application 116 by other entities in FIG. 1.

In an embodiment, when the user downloads application 116, the user is enabled to opt-in or opt-out of the creation of an associated personal database. For instance, and as shown in FIG. 1, if the user of computing device 104 opts-in to the creation of a personal database during the download of application 116, personal database 114 is created. Personal database 114 is maintained within personal data server 102 independent of computing device 104 and assigned a unique RNID (i.e., personal database identifier) by identifier access manager 118. Application 116 is configured to enable a user to interact with personal database 114 in a secure manner, as further described elsewhere herein.

Identifier server 106 includes identifier access manager 118, which is configured to issue random number identifiers, track all issued random number identifiers (in identifier repository 120), and securely interface information between a user of application 116 and other entities in system 100, thereby making identifier server 106 the secure central server or platform for the interfacing of information. For example, in identifier repository 120, identifier access manager 118 may store tables (or other formats) of identifiers, including lists of random number application identifiers that are assigned to applications by identifier access manager 118, and may store the application identifiers each with associated communication information for communicating with the corresponding application/computing device. Identifier access manager 118 may store in identifier repository 120 lists of random number manufacturer identifiers that are assigned to manufacturers by identifier access manager 118, and may store the manufacturer identifiers each with associated communication information for communicating with the corresponding manufacturer/manufacturer server. Identifier access manager 118 may store in identifier repository 120 lists of random number retailer identifiers that are assigned to retailers by identifier access manager 118, and may store the retailer identifiers each with associated communication information for communicating with the corresponding retailer/retailer server. Identifier access manager 118 may store in identifier repository 120 lists of random number personal database identifiers that are assigned to personal databases by identifier access manager 118, and may store the personal database identifiers each with associated communication information for communicating with the corresponding personal database/server. Identifier access manager 118 may store in identifier repository 120 lists of random number item identifiers that may be assigned to items and/or issued to manufacturers to be assigned to items by the manufacturers (or retailers). If identifier access manager 118 assigns the item identifiers to RFID tags, identifier access manager 118 may track them as such. Identifier access manager 118 may store the item identifiers in association with the particular manufacturer identifier of the manufacturer (or retailer identifier) to which the item identifiers were issued. In this manner, identifier access manager 118 assigns and tracks all random number identifiers, maintaining them in a secure manner Identifier access manager 118 may assign and track any number of identifiers, and their associations, in this manner, including millions, billions, or even trillions of random number identifiers. In embodiments, identifier access manager 118 is configured to securely interface information between a user of application 116, manufacturer item database 124, and retailer's item database 126 using the random number identifiers.

In embodiments, computing devices of providers (e g, manufacturers and retailers) include item databases that store specific item information corresponding to items. For instance, as shown in FIG. 1, manufacturer server 108 includes manufacturer item database 124, which includes specific item information corresponding to each applicable item manufactured by the manufacturer associated with manufacturer server 108 in system 100. As noted above, each item is assigned a unique manufacturer item RNID (i e, manufacturer item identifier) issued by identifier access manager 118 to the manufacturer. For instance, identifier access manager 118 may issue a batch of random number identifiers to the manufacturer to be used by the manufacturer to assign to items. These manufacturer item identifiers are received and stored by manufacturer identifier manager 128 in manufacturer item database 124 in association with specific item information identifying the associated items, and are also maintained in identifier repository 120 (without the specific item information). Accordingly, manufacturer identifier manager 128 manages all random number identifiers assigned by identifier server 106 to the manufacturer in manufacturer item database 124. For instance, in manufacturer item database 124, manufacturer identifier manager 128 may maintain any number of random number manufacturer identifiers assigned to the manufacturer that uniquely and privately identify the manufacturer, and any random number item identifiers assigned to the manufacturer for association with actual items by the manufacturer (and which may be programmed into RFID tags by the manufacturer or otherwise associated with the items of the manufacturer), which may number in the hundreds, thousands, millions, and greater numbers. In manufacturer item database 124, manufacturer identifier manager 128 may associate a manufacturer item identifier (e.g., generated by the manufacturer) that identifies the corresponding manufacturer item with each random number item identifier, as well as associating specific product information (e.g., an image, item description, item ingredients, etc.) that describes the item identified by the associated manufacturer item identifier with each random number item identifier. As such, when specific item information for an item corresponding to a manufacturer item identifier is requested by identifier access manager 118 (e.g., on behalf of a user), the corresponding specific item information may be accessed in manufacturer item database 124 by manufacturer identifier manager 128 and returned to identifier access manager 118.

Similarly, retailer server 110 is associated with a retailer, and includes retailer's item database 126, which includes specific item information corresponding to each item in the retailer's control (e.g., items of the manufacturer associated with manufacturer server 108 that that retailer is attempting to sell). Each item may be assigned a unique retailer item RNID by the retailer (e.g., from a batch of random number identifiers issued to the retailer by identifier access manager 118). The retailer item RNIDs are stored in retailer's item database 126 along with specific item information for each item, and are maintained in identifier repository 120 (without specific item information) at identifier server 106. As such, when specific item information for an item corresponding to a retailer item identifier is requested by identifier access manager 118 (e.g., on behalf of a user), the corresponding specific item information may be accessed in retailer's item database 126 by retailer server 110, and returned to identifier access manager 118.

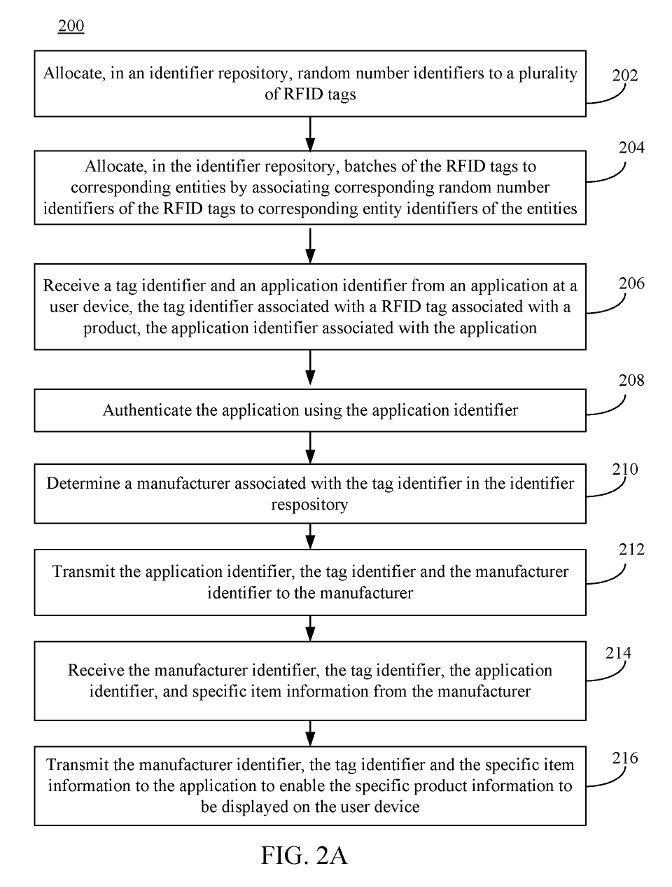

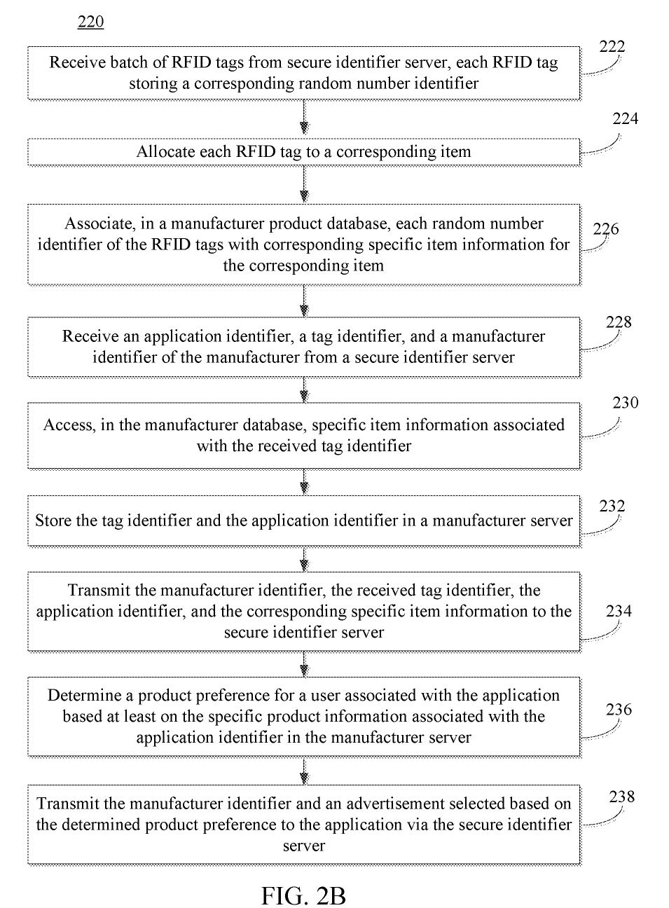

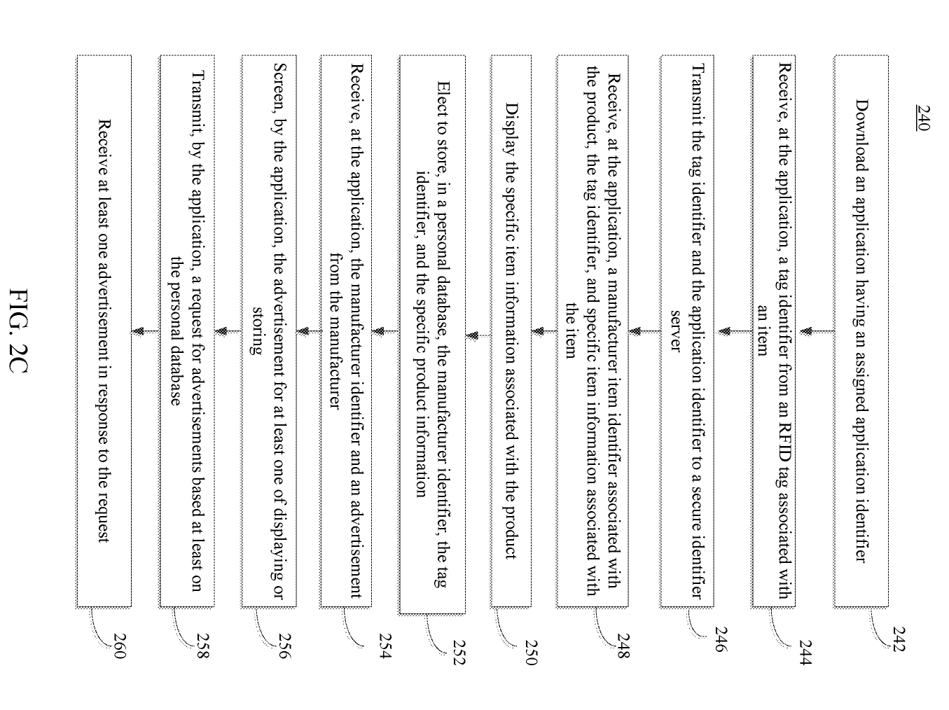

Accordingly, in embodiments, identifier server 106 may function as a conduit for communications in system 100 with regard to items, while maintaining privacy for users and other entities. Identifier server 106, application 116, manufacturer server 108, and retailer server 110 may be configured in various ways to perform such communications, in embodiments. For instance, FIGS. 2A-2C show flowcharts for interfacing item information while maintaining user privacy using RNID tags, according to example embodiments. In particular, FIG. 2A shows a flowchart 200 in an identifier server for interfacing item information, FIG. 2B shows a flowchart 220 in a manufacturer server for interfacing item information, and FIG. 2C shows a flowchart 240 in an application in a user device for interfacing item information, according to example embodiments. Flowchart 200 may be implemented by identifier server 106, flowchart 220 may be implemented by manufacturer server 108, and flowchart 240 may be implemented by application 116. It should be noted that while manufacturer server 108 is referenced with respect to flowchart 220, retailer server 110 may additionally operate according to flowchart 220. Furthermore, FIGS. 2A-2C may be performed in various orders and not all steps need be performed in all embodiments.

FIGS. 2A-2C are described with reference to system 100 in FIG. 1. Other structural and operational embodiments will be apparent to persons skilled in the relevant art(s) based on the following discussion regarding flowcharts 200, 220, and 240 and system 100 of FIG. 1. Initially, random number identifiers are distributed to entities in system 100, as described with respect to steps 202, 204 (flowchart 200), steps 222, 224, 226 (flowchart 220), and step 242 (flowchart 240). It is noted that flowcharts 200, 220, and 240, and the following description refers to RFID tags that contain random number identifiers being associated with items. However, in other embodiments, the random number identifiers may be associated with items in other manners, including by being stored in memory of the item (e.g., the case of electronic devices), in software of the item (e.g., in the case of software programs), in a wireless transceiver of the item that can communicate in a similar manner as an RFID tag or otherwise, and in other manners. The embodiments herein, including those described with reference to flowcharts 200, 220, and 240, are also applicable to the random number identifiers being directly associated with items, and thus flowcharts 200, 220, and 240 and further embodiments herein may be modified in such manner.

In particular, in step 202 of flowchart 200 of FIG. 2A (performed at identifier server 106), random number identifiers are allocated in an identifier repository to a plurality of RFID tags. With reference to FIG. 1, identifier server 106 includes identifier access manager 118, which is configured to issue random number identifiers, and track all issued random number identifiers by storing them in identifier repository 120. In an embodiment, random number identifiers are allocated to a plurality of RFID tags in identifier repository 120. The RFID tags are manufactured by an entity (related to or unrelated with identifier server 106) in any manner, including as described elsewhere herein or otherwise known. A random number identifier (tag RNID—TRNID) is generated for each RFID tag, is stored in identifier repository 120 to indicate the random number identifier as having been assigned to an RFID tag, and is programmed (stored) into the memory of the assigned RFID tag. It is noted that random number identifiers may be generated by identifier access manager 118 in any manner by identifier access manager 118, including using pseudorandom number generators (PRNGs) (algorithms for automatically generating chains of numbers with random properties), from probability distribution functions, hardware true random number generators (TRNGs), cryptographic algorithms, etc.

In step 204, batches of the RFID tags are allocated in the identifier repository to corresponding entities by associating corresponding random number identifiers of the RFID tags to the corresponding entity identifiers of the entities. For example, and with reference to FIG. 1, identifier repository 120 allocates batches of the RFID tags to corresponding entities by associating batches of random number identifiers assigned to the RFID tags with random number identifiers associated with the entities. For instance, a first batch of RFID tags of any number may be associated with the manufacturer identifier (Manufacturers Random Number ID—MRNID) assigned to the manufacturer associated with manufacturer server 108. In a like manner, a second batch of RFID tags may be assigned to the retailer associated with retailer server 110.

Referring to flowchart 220 in FIG. 2B (performed at manufacturer server 108), in step 222, a batch of RFID tags are received from a secure identifier server, each RFID tag storing a corresponding random number identifier. For example, and with reference to FIG. 1, manufacturer server 108 may receive the first batch of RFID tags from the RFID tag manufacturer and/or other entity associated with identifier server 106. Manufacturer server 108 also receives a list (in electronic form) of the random number identifiers associated with the RFID tags.

In step 224, each RFID tag is allocated to a corresponding item. For example, and with reference to FIG. 1, the manufacturer allocates each RFID tag of the first batch to a corresponding item by attaching each RFID tag directly to the corresponding item, or to packaging of the corresponding item.

In step 226, in a manufacturer item database, each random number identifier of the RFID tags is associated with corresponding specific item information for the corresponding item. For example, and with reference to FIG. 1, manufacturer identifier manager 128 of manufacturer server 108 associates in manufacturer item database 124 each random number identifier of the RFID tags in the first batch with corresponding specific product information (e.g., a barcode, a product number, etc.) of the item to which the RFID tag was allocated.

Referring to flowchart 240 in FIG. 2C (performed at application 116), in step 242, an application having an assigned application identifier is downloaded. For example, with reference to FIG. 1, computing device 104 downloads application 116. Application 116 has an assigned random number application identifier (RNID app identifier—ARNID), which is stored in identifier repository 120 without any identifying information for the user of computing device 104. In this manner, application 116 can be interacted with by entities in system 100 using the application identifier without violating the privacy of the user)

Following this set up process, the user of application 116 may interact with items for sale by the manufacturer (or retailer). Such interactions are described with respect to steps 206-216 (flowchart 200), steps 224-234 (flowchart 220), and steps 244-250 (flowchart 240).

Referring to flowchart 240 in FIG. 2C (performed at application 116), in step 244, the application receives a tag identifier from an RFID tag associated with an item. For example, with reference to FIG. 1 and discussed in detail hereinafter, application 116 scans a RFID tag associated with an item to receive a tag identifier. The user may have viewed the item at the premises of a retailer, the manufacturer, etc., and may be interested in learning more about the item and/or may be interested in purchasing the item. As such, the user may read the RFID tag associated with the item using computing device 104. In an embodiment, computing device 104 is capable of reading RFID tags, such as by having a built in RFID tag reader (e.g., by transmitting a carrier signal from an RF transmitter at an appropriate frequency, and receiving with an RF receiver the tag identifier from RFID tags in the vicinity). Application 116 (or other application on computing device 104) may provide a user interface with which the user can interact to cause computing device 104 to read the RFID tag. Application 116 receives the read tag identifier. Note that as mentioned above, in the case where an RFID tag is not associated with the item, a random number item identifier associated with the item may instead by scanned or otherwise received from the item by application 116.

In step 246, the tag identifier and the application identifier are transmitted to a secure identifier server. For example, the user of application 116 may request application 116 to provide information regarding the item that is additional to what the user may discern from viewing the item itself. In response, application 116 may transmit the read tag identifier and the application identifier (assigned to application 116) to identifier access manager 118 of identifier server 106.

Referring to flowchart 200 of FIG. 2A (performed at identifier server 106), in step 206, a tag identifier and an application identifier are received from an application at a user device, the tag identifier associated with a RFID tag associated with an item of a plurality of items and the application identifier associated with the application. For example, with reference to FIG. 1, identifier access manager 118 receives the tag identifier and application identifier from application 116 running at computing device 104. Note that as mentioned above, in an embodiment where an RFID tag is not associated with the item, a random number item identifier associated with the item may instead by received. The random number item identifier may be used throughout the rest of the description of flowcharts 200, 220, and 240 in lieu of the tag identifier in such an embodiment.

In step 208, the application is authenticated using the application identifier. For instance, with reference to FIG. 1, identifier access manager 118 authenticates application 116, such as by comparing the received application identifier to an application identifier stored in identifier repository 120. In this manner, identifier access manager 118 determines that a request for information regarding an item has been made from a registered application, and thus may be honored.

In step 210, a manufacturer identifier associated with the received tag identifier is determined from the identifier repository. For instance, with reference to FIG. 1, identifier access manager 118 searches identifier repository 120 to determine a manufacturer identifier for the manufacturer associated with the received tag identifier. For instance, identifier repository 120 may maintain lists that match manufacturer identifiers with the batches of RFID tag identifiers allocated to the manufactures assigned those manufacturer identifiers. Once the manufacturer identifier is determined, Identifier access manager 118 may retrieve an address for communication with the manufacturer (e.g., a URL, email address, etc.) from identifier repository 120 or elsewhere, to enable communications with manufacturer item database 124 of the manufacturer.

In step 212, the application identifier, the tag identifier and the manufacturer identifier are transmitted to the manufacturer. For instance, with reference to FIG. 1, identifier access manager 118 transmits the application identifier, the tag identifier and the manufacturer identifier to manufacturer server 108 (e.g., using the determined address for the manufacturer).

Referring to flowchart 220 of FIG. 2B (performed at manufacturer server 108), in step 228, an application identifier, a tag identifier, and a manufacturer identifier of the manufacturer are received from a secure identifier server. As noted above, manufacturer server 108 receives the application identifier, the tag identifier, and the manufacturer identifier from identifier server 106.

In step 230, in the manufacturer database, the received tag identifier is used to access specific item information associated with the tag identifier. For instance, and with reference to FIG. 1, manufacturer identifier manager 128 accesses manufacturer item database 124 with the received tag identifier to search for associated specific item information, which corresponds to the item, in manufacturer item database 124. Such specific item information may include an item name, an item manufacturer name, a place of manufacture of the item, a list of ingredients and/or components of the item, instructions for using and/or building the item, a list of similar items, and/or any other information relevant to the item. The specific item information may include one or more identifiers for the item, including a serial number, a barcode, etc.

In step 232, the tag identifier and the application identifier are stored in a manufacturer server. For instance, and with reference to FIG. 1, the tag identifier and the application identifier are stored by manufacturer identifier manager 128 in an archive of manufacturer server 108 in association with each other. In this manner, the manufacturer (e.g., via manufacturer ad manager 130) is enabled to determine advertisements related to the item corresponding to the tag identifier, to direct to the application associated with the application identifier. Such advertisements may be of interest to the user of the application, as evidenced by the user's apparent interest in the item.

In step 234, the manufacturer identifier, the received tag identifier, the application identifier, and the corresponding specific item information are transmitted to the secure identifier server. For instance, and with reference to FIG. 1, manufacturer server 108 transmits the manufacturer identifier, the received tag identifier, the application identifier, and the corresponding specific item information (accessed from manufacturer item database 124 by manufacturer identifier manager 128) to identifier server 106. It is noted that manufacturer server 108 communicates with application 116 (and the user) through identifier server 106 using the random number application identifier. The random number application identifier is used for entities to communicate with application 116 and the user, in lieu of any other identifying information for the user. Other identifying information for the user's instance of application 116, and for the user himself/herself, is not available to manufacturer server 108 (and retailer server 110), thereby maintaining privacy for the user.

Referring to flowchart 200 of FIG. 2A (performed at identifier server 106), in step 214, the manufacturer identifier, the tag identifier, the application identifier, and specific item information are received from the manufacturer. For instance, with reference to FIG. 1, identifier access manager 118 receives the manufacturer identifier, the tag identifier, the application identifier, and specific item information from manufacturer server 108.

In step 216, the manufacturer identifier, the tag identifier and the specific item information are transmitted to the application to enable the specific item information to be displayed on the user device. For instance, with reference to FIG. 1, identifier access manager 118 transmits the manufacturer identifier, the tag identifier, and specific item information to application 116.

Referring to flowchart 240 in FIG. 2C (performed at application 116), in step 248, a manufacturer identifier associated with the item, the tag identifier, and specific item information associated with the item are received at the application. For instance, and as noted above, application 116 receives the manufacturer identifier, the tag identifier, and specific item information from manufacturer server 108 to enable the specific item information to be presented (e.g., displayed) by application 116 at computing device 104.

In step 250, the specific item information associated with the item is displayed. For instance, and with reference to FIG. 1, the received specific item information is displayed to a user of computing device 104 via application 116. The user is enabled to review the specific item information to learn more about the item, including manufacturing information, instructions on how to make and/or use, ingredients/components, a list of similar items, etc. Furthermore, the display of the specific item information enables the user of the application to verify that the tag identifier is associated with the proper item. For example, the specific item information may include one or more of a name of the item, a manufacturer name for the item, one or more pictures of the item, a description of the item, a list of components/ingredients of the item, nutritional information for the item (in the case of a food item), and/or any further information associated with the item. The user of the application is enabled to compare the specific item information that identifies the item with the actual item itself, to confirm that the tag identifier read from the tag associated with the item (or the random number identifier otherwise obtained from the item by the application) is associated actually associated with the item, and therefore that the RFID tag was not detached from another item and attached to this item by accident or intentionally, that the incorrect manufacturer item identifier is not associated with the item (in the manufacturer product database), and/or that another incorrect identifier association exists for the item. Still further, if the user decides to purchase the item, a cashier (human or automated) may “ring-up” the item at a cash register and/or via an automatic scanning technique of a purchase transaction system, and also receive the specific product information for the item in a similar manner as application 116 receives the specific product information. For instance, the purchase transaction system (PTS) may be assigned a PTS RNID, and may use the RNID to obtain the specific product information (e.g., transmitting the PTS RNID and tag identifier to the identifier server 106, which determines the manufacturer RNID, transmits them to manufacturer server 108 and receives them back with the specific product information, and transmits the PTS RNID, tag identifier, manufacturer RNID, and specific product information to the purchase transaction system). In a like manner, application 116 and the PTS may be enable to access retailer specific product information for the item from retailer server 110, including similar information to the manufacturer specific product information, as well as pricing information for the item. The human or automated cashier may compare the manufacturer and/or retailer specific product information to the item, visually and/or electronically, to determine if the specific product information matches the item, and in effect, whether the tag identifier matched the item. This may protect against theft, where an unscrupulous person might attach a tag identifier of a low-cost item (e.g., a can of soup) to a high-cost item (e.g., a television) in an attempt to only pay the cost of the low-cost item rather than the cost of the high-cost item, because the cashier is enabled to determine a mismatch between the actual item and the specific product information for the item.

In step 252, the manufacturer identifier, the tag identifier, and the specific item information are elected for storage in a personal database. For instance, and with reference to FIG. 1, the manufacturer identifier, the tag identifier, and the specific item information may be stored in personal database 114 if the user desires. In this manner, the user may maintain this information for future reference.

As noted above, embodiments described herein enable the retrieval of advertisement information, including enable the manufacturer to target advertising to the user of the application. Example embodiment for enabling such advertisement are described as follows with respect to steps 236, 238 (flowchart 220), and steps 254-260 of flowchart 240 in FIG. 2C.

With reference to flowchart 220 in FIG. 2B (performed at manufacturer server 108), in step 236, an item preference is determined for a user associated with the application based at least on the specific item information associated with the application identifier in the manufacturer server. For instance, and with reference to FIG. 1, manufacturer ad manager 130 of manufacturer server 108 determines an item preference for a user associated with application 116 based at least on the specific item information associated with the item. By virtue of the user interacting with the item to receive the specific item information, it may be discerned that the user is interested in the item and similar items. Accordingly, the specific item information may be used by manufacturer ad manager 130 to determine item preferences of the user to select advertisements for display to the user. Such item preferences may include item type, item features (e.g., size, color, shape, etc.), other items made by the manufacturer, etc.

In step 238, the manufacturer identifier and an advertisement selected based on the determined item preference are transmitted to the secure identifier server. For instance, and with reference to FIG. 1, the manufacturer identifier and an advertisement selected based by manufacturer advertisement manager 130 (e.g., at manufacturer server 108 or elsewhere) based on the determined item preference are transmitted from manufacturer server 108 to application 116 via identifier server 106.

Referring to flowchart 240 in FIG. 2C (performed at application 116), in step 254, the manufacturer identifier and an advertisement are received at the application from the manufacturer. For instance, as noted above and with reference to FIG. 1, the manufacturer identifier and an advertisement are received at application 116 from manufacturer server 108 via identifier server 106.

In step 256, the advertisement is screened by the application for at least one of displaying or storing. For instance, and with reference to FIG. 1, the received advertisement is screened by application 116 to be displayed on computing device 104, stored in personal database 114, or both. Application 116 may screen the advertisement based on preferences of the user (e.g., for viewing ads, for viewing specific types of ads, etc.).

In step 258, a request for advertisements is transmitted by the application based at least on the personal database. For instance, and with reference to FIG. 1, a request for advertisements is transmitted from application 116 based at least on personal database 114. As described above, personal database 114 may store information about items viewed by the user. The item information may be used by application 114 to generate a request for advertisements for the user to view.

In step 260, at least one advertisement is received in response to the request. For instance, and with reference to FIG. 1, at least one advertisement is received by application 116 from either manufacturer server 108, retailer server 110, or both in response to the request of step 258.

Accordingly, flowcharts 200, 220, and 240 described numerous embodiments for private communications regarding items between entities, including a setup process, a process for obtaining information regarding an item for a user, and a process for providing advertisements (e.g., ads, coupons, deals, etc.) to the user based on the user's interactions with items. Further embodiments and details of the above-described embodiments are provided as follows.

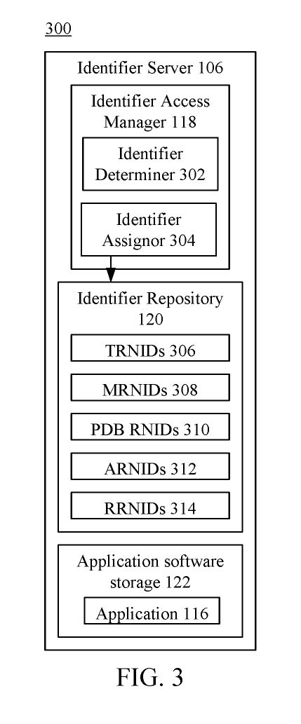

For instance, as described above, an access manager, such as identifier access manager 118 of FIG. 1, is configured to assign and store unique identifiers for each entity and item in system 100. For instance, FIG. 3 shows a block diagram 300 of identifier server 106 of FIG. 1, according to an example embodiment. As shown in FIG. 3, identifier access manager 118 includes identifier determiner 302 and identifier assignor 304. Identifier repository 120 includes TRNIDs (tag random number identifiers) 306, MRNIDs (manufacturer random number identifiers) 308, PDB RNIDs (personal database random number identifiers) 310, ARNIDs (application random number identifiers) 312, and RRNIDs (retailer random number identifiers) 314. Application software storage 122 includes application 116. These and further features of FIG. 3 are described as follows.

As discussed above, when an item is enrolled into the system, identifier access manager assigns multiple identifiers to be stored in an identifier server. For instance, an item may be assigned a manufacturer identifier, a tag identifier, and a retailer item identifier to be stored in an identifier repository. Furthermore, when an application is downloaded to a device, the identifier access manager assigns an application identifier to the downloaded application software and if the user opts-in to the creation of a personal database, a personal database identifier is assigned to the corresponding personal database. For instance, and as shown in FIG. 3, identifier assignor 302 assigns identifiers and stores them in identifier repository 120. As shown in FIG. 3, the tag identifiers are stored in TRNIDs 306, the manufacturer identifiers are stored in MRNIDs 308, the personal database identifiers are stored in PDB RNIDs 310, the application identifiers are stored in ARNIDs 312, and the retailer identifiers are stored in RRNIDs 314.

As noted above, application software may be downloaded from application software storage 122. For instance, and as shown in FIG. 3, application 116 is stored in application software storage 122 such that a user of computing device 104 is enabled to download application 116.

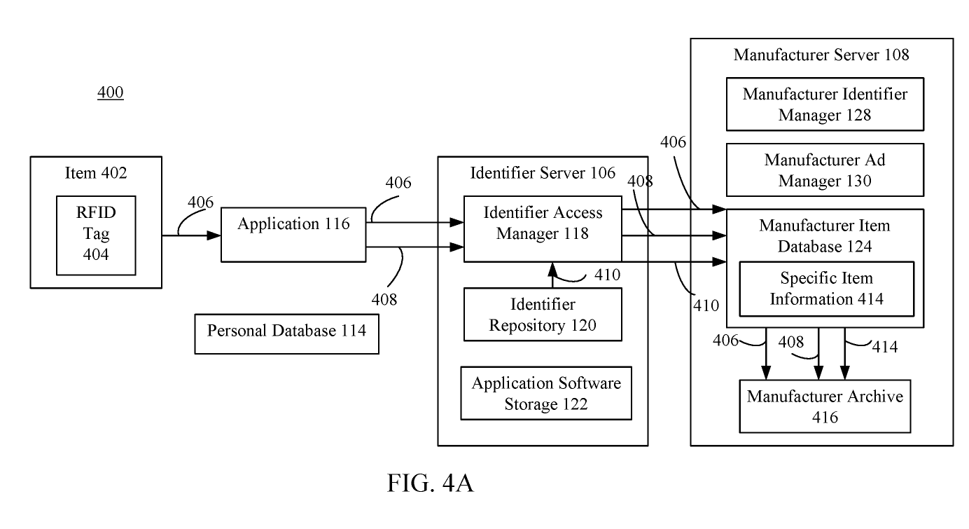

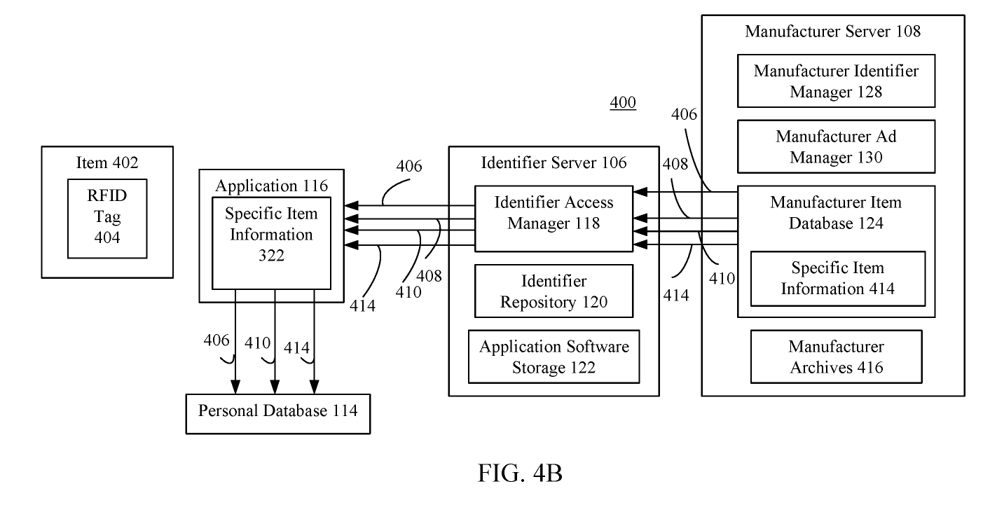

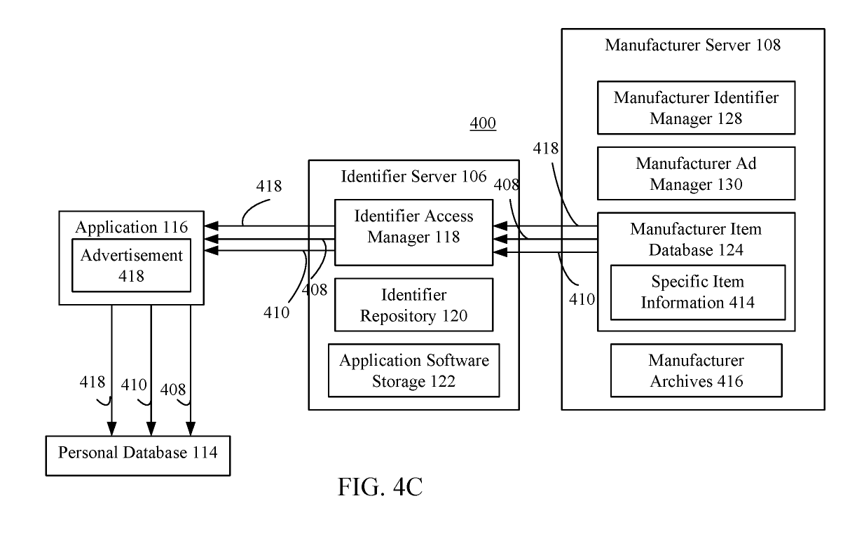

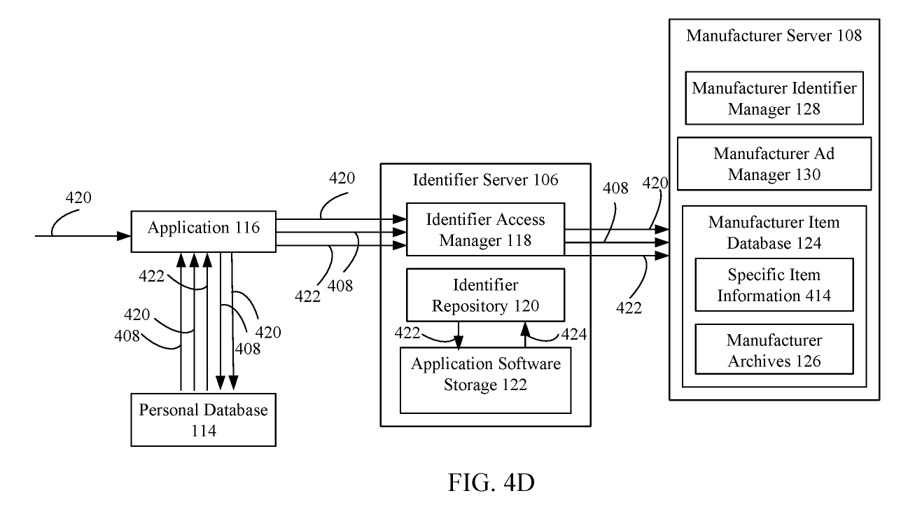

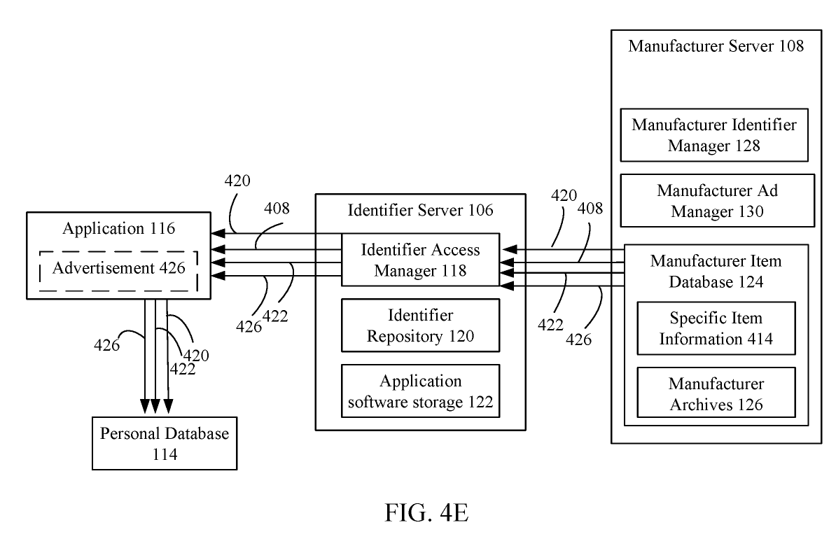

According to embodiments, a user of a computing device, such as computing device 104 of FIG. 1, is enabled to obtain specific item information relating to a scanned tag without providing any private information by identifier access manager 118. Example processes for obtaining such information in system 100 are illustrated with respect to FIGS. 4A-4E. FIGS. 4A-4E illustrate communications of information within system 100 and 300 regarding providing such information, as well as additional embodiments. More specifically, FIGS. 4A-4B illustrate the retrieving of item information in response to the scanning of an item, FIG. 4C illustrate the targeting advertising of a manufacturer, and FIGS. 4D-4E illustrate the retrieval of advertisement information in response to a user query. FIGS. 4A-4E are described as follow.

As shown in FIG. 4A, system 400 includes item 402, application 116, identifier server 106, personal database 114, and manufacturer server 108. Identifier server 106 includes identifier access manager 118, identifier repository 120, and application software storage 122. Manufacturer server 108 includes manufacturer identifier manager 128, manufacturer ad manager 130, manufacturer item database 124, and a manufacturer archive 416. Item 402 includes a RFID tag 404. RFID tag 404 has an assigned tag identifier 406 that is stored in identifier repository 120 with corresponding identifiers (i.e., a manufacturer identifier and a retailer identifier). As shown in FIG. 4A, and with continued reference to FIG. 1, application 116 receives tag identifier 406. For instance, a user may interact with application 116 to enable RFID tag 404 to be scanned on item 402 to retrieve tag identifier 406.

As shown in FIG. 4A, application 116 receives tag identifier 406, and in response, transmits tag identifier 406 and an application identifier 408 that is associated with application 116 to identifier access manager 118. In response to receiving tag identifier 406 and application identifier 408, identifier access manager 118 authenticates application 116 by acknowledging application identifier 408. Once application 116 is authenticated, identifier access manager 118 determines a manufacturer identifier 410 associated with tag identifier 406. Identifier access manager 118 transmits tag identifier 406, application identifier 408, and manufacturer identifier 410 to manufacturer item database 124. As such, specific item information 414 is retrieved for the item having a manufacturer item identifier associated with tag identifier 406. In embodiments, and as shown in FIG. 4A, manufacturer identifier archive 416 stores application identifier 408, tag identifier 406, and specific item information 414 for later optional future push advertising.

Referring to FIG. 4B, and as noted above, manufacturer identifier manager 128 is configured to access manufacturer item database 124 to obtain specific item information 414 that corresponds to tag identifier 406. Accordingly, manufacturer server 108 transmits tag identifier 406, application identifier 408, manufacturer identifier 410, and specific item information 414 to identifier access manager 118. Identifier access manager 118 then transmits tag identifier 406, application identifier 408, manufacturer identifier 410 and specific item information 322 to application 116. Application 116 displays specific item information 322 to the user of computing device 104 via application 116. In an embodiment, application 116 transmits information to personal database corresponding to the user of computing device 104 and application 116. As shown in FIG. 4B, application 116 transmits tag identifier 406, manufacturer identifier 410, and specific item information 414 to be stored in personal database 114.

Referring to FIG. 4C, and as noted above, manufacturer identifier archive 416 stores information for later push or targeted advertising of an advertisement selected based on the stored information. Accordingly, manufacturer ad manager 130 of manufacturer server 108 may select an advertisement 418 and transmit advertisement 418, application identifier 408, and manufacturer identifier 410 to identifier access manager 118. Identifier access manager 118 then transmits advertisement 418, application identifier 408, and manufacturer identifier 410 to application 116. Application 116 displays advertisement 418 to the user of computing device 104 via application 116. In an embodiment, application 116 transmits advertisements to personal database 114 corresponding to the user of computing device 104 and application 116. As shown in FIG. 4C, application 116 transmits advertisement 418, application identifier 408, and manufacturer identifier 410 to be stored in personal database 114. In an embodiment, a fee may be charged by identifier server 106 to the manufacturer for the service of facilitating such advertising.

In embodiments, and as discussed above, advertisements may be transmitted to a user in response to a user query. As shown in FIG. 4D, application 116 receives a notification of a user request for advertisements 420 associated with an item. In response to receiving request 420, application transmits request 420 and application identifier 408 to personal database 114. Personal database 114 searches for manufacturer identifiers associated with the item of request 420. In an embodiment, personal database 114 returns any manufacturer identifiers associated with the item of request 420 to application 116 along with request 420 and application identifier 408. For instance, as shown in FIG. 4D, personal database 114 returns query 420 with manufacturer identifier 422 to application 116. Application 116 then transmits application identifier 408, request 420, and manufacturer identifier 422 to identifier access manager 118.

In embodiments, in response to receiving an application identifier, a request, and at least one manufacturer identifier, identifier access manager performs the following for each obtained manufacturer identifier. With continued reference to FIG. 4D, a manufacturer is determined from the identifier repository that is associated with the manufacturer identifier. For instance, as shown in FIG. 4D, the manufacturer (and the corresponding URL information) may be determined to be associated with manufacturer identifier 422 in identifier repository 120. Accordingly, identifier access manager 118 transmits application identifier 408, manufacturer identifier 422, and request 420 to manufacturer server 108 using the determined address.

Referring now to FIG. 4E, and as noted above, in response to receiving application identifier 408, request 420, and manufacturer identifier 422, manufacturer ad manager 130 of manufacturer server 108 selects advertisement 426 based at least on manufacturer identifier 422, request 420, or both. In embodiments, the manufacturer transmits any advertisements associated with the item request or the manufacturer identifier to the secure identifier server. For instance, and as shown in FIG. 4E, manufacturer server 108 transmits application identifier 408, request 420, advertisement 426, and manufacturer identifier 422 to identifier server 118. Identifier server 118 transmits application identifier 408, manufacturer identifier 422, request 420, and advertisement 426 to application 116 to be displayed to a user of computing device 104. In an embodiment, and as shown in FIG. 4E, application 116 may display advertisement 426 to user of computing device 104 via application 116. Furthermore, application 116 may transmit advertisement 116, manufacturer identifier 422, and advertisement 426 to be stored in personal database 114.

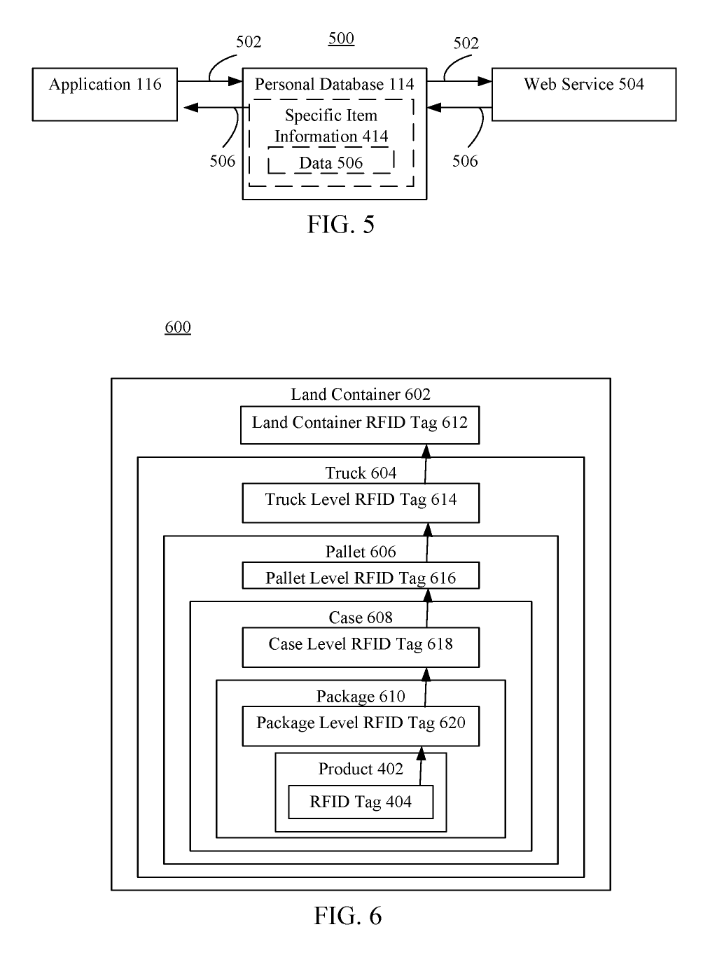

In embodiments, and as discussed above, when the user “opt-ins” and personal database 114 is created, the user may further retrieve information relating to stored items. For instance, FIG. 5 shows a block diagram of a system 500 for data mining. As shown in FIG. 5, system 500 includes application 116 and personal database 114 of FIG. 1 interacting with web service 504. The features of system 500 are described as follows with respect to FIG. 1.

Personal database 114 is configured to use stored item information to “data mine” for further desired item information from various multiple on-line database(s) and then present the data to the user in a relevant and actionable manner. For instance, and as shown in FIG. 5, personal database 114 receives a query 502 relating to stored specific item information 414. Personal database transmits query 502 to web service 504. Web service 504 completes a web search to obtain data 506 relating to specific item information 414. Web service 504 then transmits data 506 to be stored in personal database 114. Accordingly, in an embodiment, personal database is enabled to transmit data to the user, when necessary, to be presented in a relevant and actionable manner. The information may be used by the user for later reference and decision-making. As shown in FIG. 5, personal database 114 transmits data 506 to application 116 for display to the user. In embodiments, during this process, the user may be enabled to interact with web service 504 via a screen of application 116 or voice to help direct such a search.

As noted above, each item in system 100 is assigned a RFID tag with a random number tag identifier. Each item may be combined in a package for different types of transport. The packages may be combined in a case, the cases may be combined in a pallet, the pallets may be combined in a truck and the trucks may be combined in a land container. Thus, each level of combining can be assigned a unique RNID. This process may be referred to as “nesting.” For instance, FIG. 6 shows a block diagram of a block diagram 600 showing example nesting levels for item 402. As shown in FIG. 6, system 600 includes a land container 602, a truck 604, a pallet 606, a case 608, a package 610, and item 402, with each level containing the next listed level (e.g., land container 602 contains truck 604, etc.). Land container 602 attaches land container RFID tag 612, truck 604 attaches truck RFID tag 614, pallet 606 attaches pallet RFID tag 616, case 608 attaches case level RFID tag 618, package 610 attaches package level RFID tag 620 and item 402 attaches RFID tag 404. The features of block diagram 600 are described as follows with respect to FIGS. 1 and 3.

In embodiments, RNID tags may be placed on each level of an item. In this way, a larger level RFID tag can be scanned such that each included RFID tag is accessible via that one scan. For instance, as shown in FIG. 6, when package level RFID tag 620 is scanned, each item RFID tag included in package 610 is accessible. When case level RFID tag 618 is scanned, each package level RFID tag included in case 608 is accessible along with each item RFID tag included in package 610. When pallet level RFID tag 616 is scanned, each case level RFID tag included in pallet 606 is accessible along with each package level RFID tag included in case 608 and each item RFID tag included in package 610. When truck level RFID tag 614 is scanned, each pallet level RFID tag included in truck 604 is accessible along with each case level RFID tag included in pallet 606, each package level RFID tag included in case 608 and each item RFID tag included in package 610. When land container RFID tag 612 is scanned, each truck level RFID tag included in truck land container 602 is accessible along with each truck level RFID tag included in land container 602, each case level RFID tag included in pallet 606, each package level RFID tag included in case 608 and each item RFID tag included in package 610. This “nesting” may occur in many ways.

For instance, in an embodiment, application 116 may include project assistance nesting software (PANS) with a corresponding application identifier. As items are placed in a first package or box, PANS then read the tag identifiers and the tag identifiers are then placed in the secure database in a “ready to nest” mode as level 1 tag identifiers, where the numeral “1” refers to the first nesting level. For instance, and as shown in FIG. 6, RFID tag 404 is a level 1 tag identifier.

When the package or container is sealed, a verbal or keyboard command is given to PANS “next level” and a tag identifier is placed on the first package or container, and it too is read by a PANS enabled reader. It is now designated in the secure database as a level 2 tag identifier and is then linked to the level 1 tag identifier in the secure database, where the numeral “2” refers to the second nesting level. When these packages or containers are placed into second shipping boxes or containers, their level 2 tag identifiers are read by a PANS enabled reader and then are placed into the secure database in “ready to nest” mode. For instance, and as shown in FIG. 6, package level RFID tag 620 is a level 2 tag identifier.

When the shipping box is sealed, a verbal or keyboard command is given to the PANS “next level” and a tag identifier is placed on it, and is then read by the PANS enabled Smartphone reader. It is now designated in the secure database as a level 3 tag identifier and is linked to the level 2 tag identifiers in the secure database, where the numeral 3 refers to the third nesting level. When the shipping boxes are then loaded onto a truck for delivery, the PANS enabled Smartphone reader reads the level 3 tag identifiers, which are placed into the secure database in “ready to nest” mode. For instance, and as shown in FIG. 6, case level RFID tag 618 is a level 3 tag identifier.

When the boxes are joined as a pallet, a verbal or keyboard command is given to the PANS “next level” and a tag identifier is placed somewhere on or in the pallet, and read by the PANS enabled Smartphone. It is now designated as a level 4 tag identifier in the secure database and is then linked to the level 3 tag identifiers in the secure database. The numeral 4 designates the fourth nesting level. At any time, during or at delivery, the entire contents of the pallet can be known by placing the PANS enabled Smartphone reader into “nest discovery” mode and reading the level 4 identifies. The level 4 identifier is sent to the secure database which links to the level 3 identifiers which link to the level 2 identifiers which link to the level 1 identifiers which link to the item data information for each of the level 1 identifiers, and the item information is read out for every item in the truck. For instance, and as shown in FIG. 6, pallet level RFID tag 616 is a level 4 tag identifier.

When the boxes are finally loaded, a verbal or keyboard command is given to the PANS “next level” and a tag identifier is placed somewhere on or in the truck, or onto a shipping manifest, and read by the PANS enabled Smartphone. It is now designated as a level 5 tag identifier in the secure database and is then linked to the level 4 tag identifiers in the secure database. The numeral 5 designates the fourth nesting level. At any time, during or at delivery, the entire contents of the truck can be known by placing the PANS enabled Smartphone reader into “nest discovery” mode and reading the level 5 identifies. The level 5 identifier is sent to the secure database which links to the level 4 identifiers which link to the level 3 identifiers which link to the level 2 identifiers which link to the item data information for each of the level 1 identifiers, and the item information is read out for every item in the truck. For instance, and as shown in FIG. 6, truck level RFID tag 614 is a level 5 tag identifier.

This process can be furthered iterated by the PANS on land containers which might have a truck within it confines. Following the process above, their tag identifiers may be designated a level 6 identifier in the secure database and may be linked to the level 5 tag identifiers. In embodiments, the PANS could be part of PAS functionality for household or retail use where items could be nested using sheets of RNID tags purchased at the local office store. For instance, and as shown in FIG. 6, truck level RFID tag 614 is a level 6 tag identifier. Furthermore, land container RFID tag 612 is a level 6 tag identifier.

Accordingly, random number identifiers may be assigned to items in a hierarchy, including by the attachment of RFID tags that store random number tag identifiers, and the hierarchy of random number item identifiers may be used to track the items via nesting (e.g., items in higher levels of the hierarchy enabled to assist in tracking items in lower levels of the hierarchy, and each lower level containing one or more items with RNIDs tracked by an item at a higher level having an RNID). The nesting of RNIDs may be applied to physical/tangible items in a hierarchy, such as the containers (as in FIG. 6), and may also be applied to less tangible (e.g., virtual) items in a hierarchy, such as entities in a social network, entities in a communication network, etc. For example, a social network may include (at a lower level) users that are each assigned RNIDs, and may include (at higher levels), friend and/or family groups each having assigned RNIDs and containing multiples of the users, interest groups each having assigned RNIDS and containing multiples of the users, national networks having assigned RNIDS each containing multiples of the friend groups, etc. With regard to communication networks, a communication network may include communication devices (e.g., smart phones, routers, servers, personal computers, sensors, wearable devices, etc.) each having assigned RNIDS, Bluetooth nets each having assigned RNIDS and containing multiples of the devices, Piconets each having assigned RNIDS and containing multiples of the Bluetooth nets, Scatternets each having assigned RNIDS containing multiples of the Piconets, etc. Accordingly, nesting using RNIDs may be applied to any tangible and intangible things that form hierarchies of any numbers of levels.

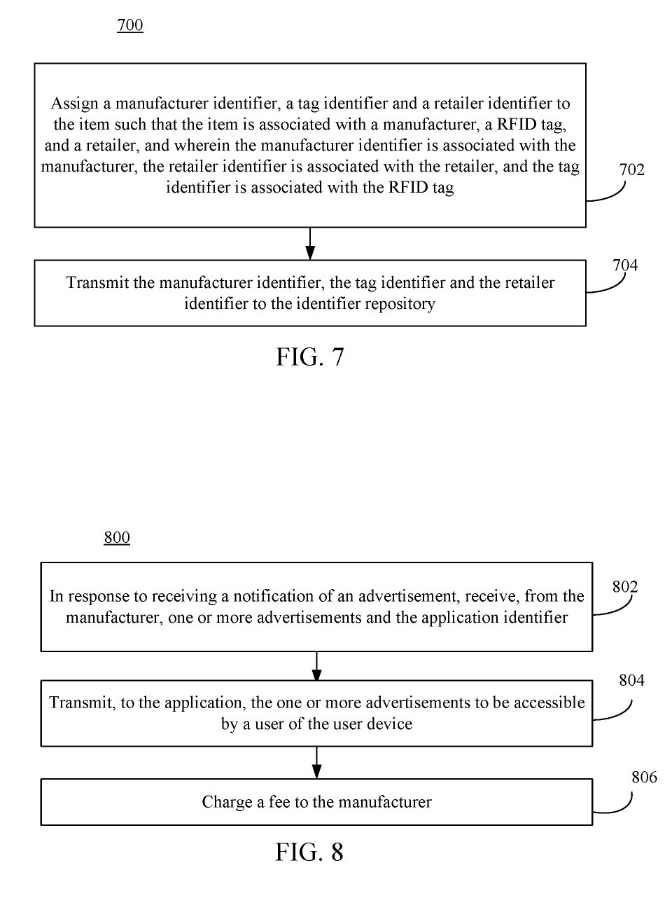

Flowcharts are described as follows that may be performed by identifier access manager embodiments described herein, as well as in flowchart 200 of FIG. 2. For instance, FIG. 7 shows a flowchart 700 for assigning random identifies to a plurality of items, according to an example embodiment. Flowchart 700 may be implemented by identifier access manager 118 of FIGS. 1, 3 and 4, in embodiments. Flowchart 700 is described as follows. Other structural and operational embodiments will be apparent to persons skilled in the relevant art(s) based on the following discussion regarding flowchart 700.

Flowchart 700 begins with step 702. In step 702, a manufacturer identifier, a tag identifier and a retailer identifier are assigned to the item such that the item is associated with a manufacturer, a RFID tag, and a retailer, and wherein the manufacturer identifier is associated with a manufacturer identifier of the manufacturer, the retailer identifier is associated with a retailer identifier of the retailer, and the tag identifier is associated with the RFID tag. For example, and with reference to FIG. 3 identifier assignor 302 assigns a manufacturer identifier, a tag identifier and a retailer identifier to each item in the system.

In step 704, the manufacturer identifier, the tag identifier and the retailer identifier are transmitted to the identifier repository. For instance, and with reference to FIG. 3, identifier assignor 302 stores each of the assigned identifiers in identifier repository 120.

As noted above, a manufacturer can transmit targeted coupons to the application associated with the application identifier. This can be accomplished in various ways. For instance, FIG. 8 shows a flowchart 800 for transmitting one or more coupons to a user, according to an example embodiment. Flowchart 800 may be implemented by identifier access manager 118 of FIGS. 1, 3 and 4, in embodiments. Flowchart 800 is described as follows. Other structural and operational embodiments will be apparent to persons skilled in the relevant art(s) based on the following discussion regarding flowchart 800.

Flowchart 800 begins with step 802. In step 802, in response to receiving a notification of a coupon alert, receive, from the manufacturer computing device, one or more coupons and the application identifier. For example, with reference to FIG. 1, identifier access manager 118 receives a notification of a coupon alert from manufacturer advertisement manager 130 of manufacturer server 108.

At step 804, the one or more coupons are transmitted to the application to be accessible by a user of the user device. For example, the received one or more coupons are transmitted from identifier access controller 118 to application 116 to enable the user of computing device 104 to access the one or more coupons.

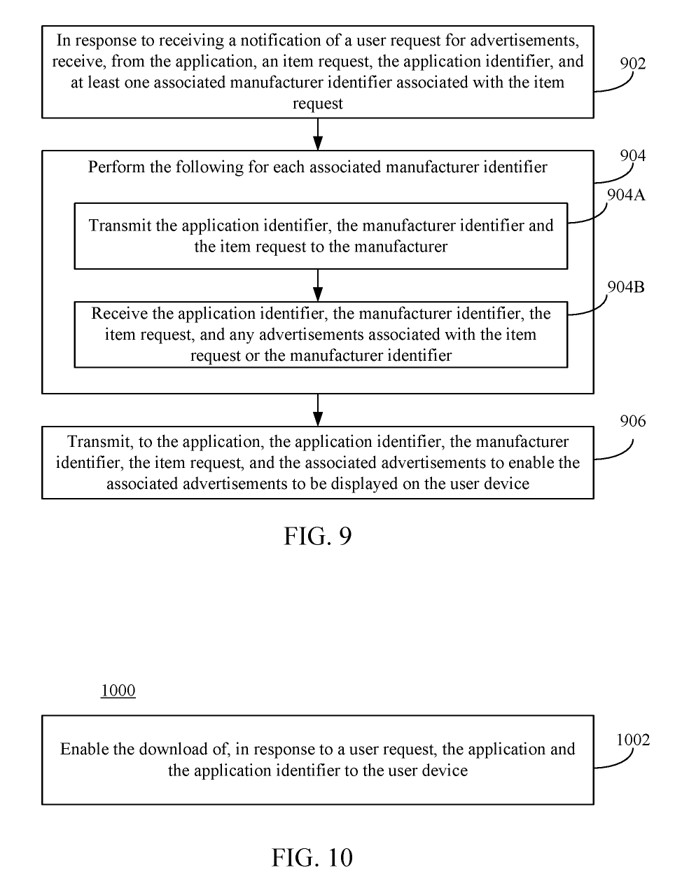

As noted above, the user of application 116 may search for coupons via the system. For instance, FIG. 9 shows another flowchart 900 for transmitting one or more coupons to a user, according to an example embodiment. Flowchart 900 may be implemented by identifier access controller 118 of FIGS. 1, 3 and 4C, in embodiments. Flowchart 900 is described as follows. Other structural and operational embodiments will be apparent to persons skilled in the relevant art(s) based on the following discussion regarding flowchart 900.

Flowchart 900 begins with step 902. In step 902, in response to receiving a notification of a user request for coupons, an item, the application identifier, and at least one associated manufacturer identifier associated with the item request are received. For example, and with reference to FIG. 1, the identifier access controller 118 receives a notification of a user request for coupons from application 116 and receives an item, the application identifier, and at least one associated manufacturer identifier associated with the item request.

At step 904, steps 904A and 904B are performed for each of the associated manufacturer identifiers.

At step 904A, the application identifier, the manufacturer identifier and the item request are transmitted to a computing device associated with the obtained manufacturer identifier. For example, and with reference to FIG. 1, application identifier, manufacturer identifier, and item request are transmitted to manufacturer server 108.

At step 904B, the application identifier, the manufacturer identifier, the item request, and any coupons or deals associated with the item request are received. For example, and with reference to FIG. 1, the application identifier, manufacturer identifier, the item request and any coupons or deals associated with the item request are received by identifier access manager 118.

In step 906, the application identifier, the manufacturer identifier, the item request, and the associated coupons or deals are transmitted to the application to enable the associated coupons or deals to be displayed on the user device. For example, and with reference to FIG. 1, the application identifier, manufacturer identifier, the item request and any coupons or deals associated with the item request are received by application 116 for display to the user of computing device 104.

As noted above, application 116 may be downloaded from identifier server 106. For instance, FIG. 10 shows a flowchart 1000 for enabling the download of application software, according to an example embodiment. Flowchart 1000 may be implemented by application software storage 122 of FIGS. 1 and 3, in embodiments. Flowchart 1000 is described as follows. Other structural and operational embodiments will be apparent to persons skilled in the relevant art(s) based on the following discussion regarding flowchart 1000.

Flowchart 1000 begins with step 1002. In step 1002, in response to a user request, the application and the application identifier are enabled to be downloaded to the user device. For instance, a user of computing device 104 may request to identifier server 106 to download application software. In response, application software storage 122 may download application 116 to computing device 104

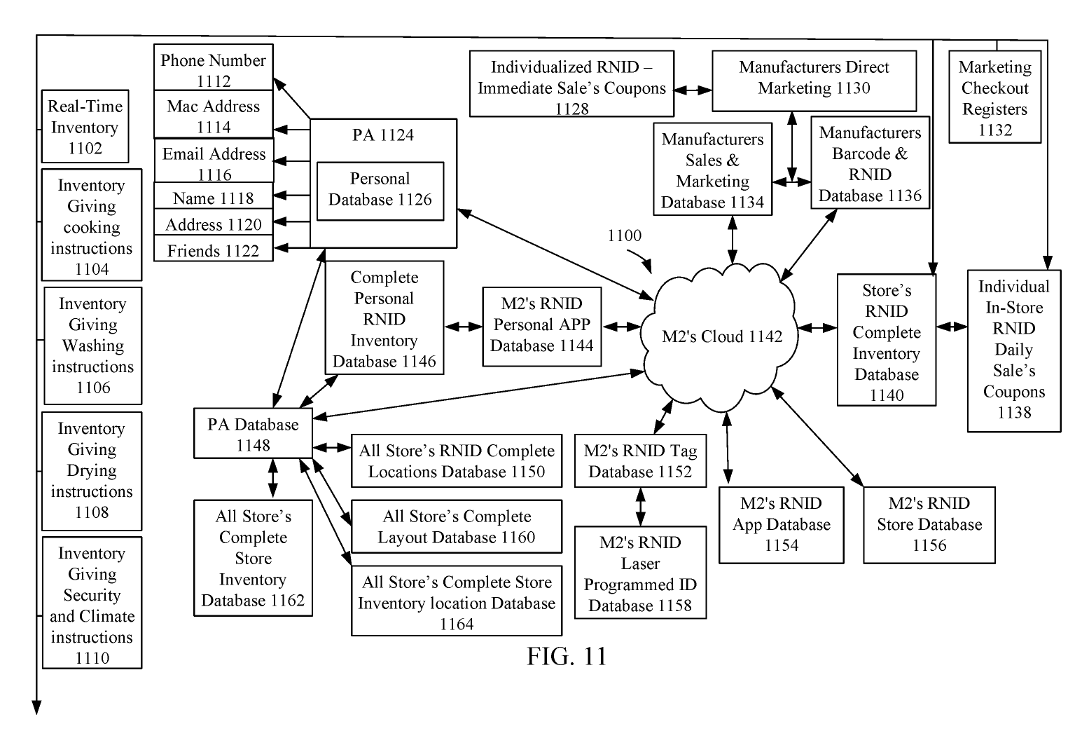

In embodiments, system 1100 may be a further embodiment of system 100 of FIG. 1, including subsystems/components thereof. For example, system 1100 includes PA 1124, M2's RNID Personal APP Database 1144, Manufacturers Sales & Marketing Database 1134, Manufacturers Barcode & RNID Database 1136, Store's RNID Complete Inventory Database 1140, M2's RNID Store Database 1156, M2's RNID App Database 1154, M2's RNID Tag Database 1152, and PA Database 1148 that are all communicatively coupled via M2's Cloud 1142. PA 1124 includes personal database 1126. System 1100 further includes complete personal RNID inventory database 1146, All Store's Completed Store Inventory Database 1162, All Store's RNID Complete Locations Database 1150, All Store's Complete Layout Database 1160, All Store's Complete Store Inventory location Database 1164, M2's RNID Laser Programmed ID Database 1158, Individual In-Store RNID Daily Sale's Coupons 1138, Marketing Checkout Registers 1132, Manufacturers Direct Marketing 1130 and Individualized RNID-Immediate Sale's Coupons 1128. PA 1124 includes phone number 1112, mac address 1114, email address 1116, name 1118, address 1120, and friends 1122. System 1100 further includes real-time inventory 1102, inventory giving cooking instructions 1104, inventory giving washing instructions 1106, inventory giving drying instructions 1108, and inventory giving security and climate instructions 1110. These features of FIG. 11 are further described in the following section.

### III. Further Embodiments

This section describes additional embodiments and further details to embodiments described elsewhere herein. The embodiments described in this subsection may be combined with each other in any manner, and can be combined with embodiments described elsewhere herein in any manner.

The present patent application describes a communication system for privately interacting between a user and external databases at various times using RNIDs. For instance, the communications may occur prior to making an item purchase, during an item purchase, and after an item purchase. The communication system further enables the storage of purchase and additional information, such that the user may retrieve stored information for use at any time. In fact, the communication system enables user or provider communication in any realm.

The example embodiments described herein are provided for illustrative purposes, and are not limiting. The examples described herein may be adapted to any type of item data interface through a personal assistance software agent using random number id's (RNIDs). Further structural and operational embodiments, including modifications and/or alterations, will become apparent to persons skilled in the relevant art(s) from the teachings herein.

U.S. Patent Application No. 62/265,972 titled, “Randomization Approach To Robust RFID Security,” which is incorporated by reference herein in its entirety, describes a Near Field Communication (NFC) Radio Frequency Identification (RFID) tag system which involves attaching read-only Random Number ID (RNID) NFC tag entities to various items that are read by an RNID NFC read-enabled reader, such as a Smart Phone Reader (SPR), operated with a RNID tag reader app (RAPP) downloaded from a secure internet site.

In an embodiment, the RNIDs are randomly generated and could be greater or equal to 64 bits (less bits could also be used but it would be less secure), and are hard-coded, such as through laser programming, into an integrated circuit read-only memory (ROM). These chips are then assembled onto various preprinted antenna substrates to produce the RNID NFC tag entities. The chip could be attached to any substrate that has a printed, etched or other manufacturing techniques used to produce antennas which are then singulated to provide for individual tag labels that are attached to finished packaging or item. The chips could also be attached to any stock materials that could be used for source tagging, such as the stock used to form boxes or wrappings for item, that has the antenna integral to that substrate. So, the definition of a tag entity is either a tag label or a source tag incorporated in the item or item packaging material. From now on, such tag entities will just be referred to as tags, but the term can refer to any of the tag entity definitions. Label tags are sold to manufactures, retailers, or other tag customers who may attach them to their items. Source tags come attached with the packaging source stock, so become associated with item when the item is packaged. Both cases are referred to as attaching tags to or with item. When they are so attached, they are enrolled in a Customer Database (CDB) or a Manufacturers Random Number ID's (MRNIDS) where the RNIDs are associated with item information, such as barcodes, or any other information for the items they are attached to. Random ID Symbols (RIDS), could also be used in the same way as with RNIDs for uniquely identifying item and interacting with item information, and is included as part of this disclosure.

In embodiments, tagged items may be any objects that are desired to have a unique random number identification, as well as unique data associated with the item. This approach is a radical departure from today's production of items identified only as a class with a barcode. One box of cereal or one can of peas is the same as another, each with the same barcode. The RNID NFC tag provides uniqueness at the item level, so now each can of peas has its own ID number, as well as the barcode identifier. This concept of uniqueness, based upon a randomly assigned identifier (the RNID) expands to the full gamut of categories to everything produced, such as for home automation, entertainment, home security, smart appliances, sensors, automotive, etc. When generated and programmed for a specific manufacturer, retailer, or any other customer, the resulting RNIDs are stored in a secure database (SDB), where each-and-every RNID is associated with a RNID that is assigned to every customer manufacturer or retailer. When a SPR is placed into close-proximity of the RNID NFC tag, the SPR reads the tag, obtaining its RNID, which is then sent over the cellular network by the SPR to the SDB which retrieves the manufacturer or retailer RNID, which is then used as authentication to access the manufacturer or retailer CDB for the item information associated with that RNID, which is then sent back to the SPR through the SDB for display on its screen.

In embodiments, this item information retrieval approach is achieved by a RNID tag reader application (RAPP) downloaded from the SDB cloud-base ecosystem (SDBES) along with a RNID app identifier (ARNID), which is used for all SDB interactions instead of customer information. This app protects the privacy of the user, and is the SPR driver for RNID NFC tag interrogation. All this app does is retrieve and present item information from SPR tag reads, and allows manufactures and retailers to push targeted advertisements to the SPR user without disclosing user information.

U.S. Patent Application No. 62/304,813 titled, “Real-Time Authentication System for Networks Using a Random Number Identification Nesting Process” (hereinafter “the '813 application”), which is incorporated by reference herein in its entirety, expands this concept to secure sensor and computer networks, and for software security.

The '813 application describes an enhancement to the concept by the downloading of application software from the SDBES that serves as an item interface assistant or software agent for the user. This can be otherwise referred to as the Item Assistant Software (PAS). The PAS could either work in conjunction with the basic Reader APP (RAPP) or include RAPP functionality within it. If it replaces the RAPP instead of interfacing with it, then it is downloaded with its own unique Application RNID app identifier (ARNID). Also, the downloaded PAS could be assigned its own email address, accessible only through the SDB.

In embodiments, when a SPR is placed into close-proximity of the RNID NFC tag, the SPR reads the tag, obtaining its TRNID. The PAS sends the TRNID and the ARNID to the SDB, which passes them along to the MRNID associated with the TRNID. The MPDB associated with the MRNID pulls up the SPI associated with the TRNID and marries the PAS ARNID with the SPI and TRNID and archives it for future push advertising to that PAS ARNID. The MPDB sends its MRNID, TRNID, SPI and PAS ARNID back to the SDB. The SDB uses the PAS ARNID to send the MPDB, MRNID, SPI and TRNID to the PAS SPR. The MPDB searches for all SPI TRNIDs associated with a specific PAS RNID to determine item preferences for the PAS RNID and attaches a targeted ad or coupon to that PAS RNID and sends it to the SDB along with its MRNID. The PAS screens the ads for desired interests of the user, displays it, and retains it and the MRNID in the PDB. If the user is interested in a particular item, the PAS searches the PDB for MRNIDs associated with such items, and sends a request for advertisements of special deals by sending the PAS ARNID, the MRNID to the SDB. The SDB sends the request to the MPDB along with the PAS RNID. If the MRNID MPDB has any special deals for the PAS ARNID it sends it to the SDB along with the PAS RNID and retains the PAS ARNID in the MPDB for future push advertising. The SDB charges a fee to forward the advertising and MRNID to the PAS. Fees could also be charged for other SDB services.

In embodiments, any of the Personal Assistants in the market, such as Apple's Siri, Braina, Google Now, Amazon Echo, Microsoft Cortana, Samsung's Voice, LG's Voice Mate, SILVIA, HTC's Hidi, and recently Viv, could be enhanced or modified to provide the functionality described below for the PAS. Or an entirely new application could be developed specifically for the PAS functionality.

In embodiments, one of the functions of the PAS is to create and continuously update a cloud-based Personal item information Database (PDB). Another function is to use item information retrieved from a tag read to glean by data mining for further desired item information from various multiple on-line database(s), and then present that data to the user in a relevant and actionable manner. For example, if a tag read results in retrieving an item barcode and related item information, the SPR, under the direction of the PAS could send this information to other associated databases in-order-to glean further item information related to that item's barcode or item description. During this process, the PAS may interact with the user via the screen or voice to help direct such a search. Information so obtained may be stored in the user's PDB for later reference and decision-making.

In embodiments, the user could use the obtained item information to either buy or not buy the item. The user could also obtain more information about the item or related items with manufacturer, retailer, and item database queries through the PAS. For example, if used within retailer/corporate/business databases then the PAS could call up any specified or required data about any item including but not limited to recalls, inventory, location, selling tendencies, reorder, and shrinkage, especially with businesses with multiple locations. For example, but not limited to, corporate managers wanting to call up specific data about “Levi Jeans” could ask the PAS how many “Jeans have we sold by store and size.” Through the answers one could determine current inventory as well as merchandise lost to “shrinkage” or where to move inventory to locations that are selling a specific item quicker. Investors in companies can even use this data for stock market analysis of what's hot and what's not.

In embodiments, other examples of information the PAS could obtain for the user include, but not limited to, receipts, warranties, instructions, features, health hazard, reviews, manuals, authorized repair people, and maybe even recipes and sales and/or manufacturer's coupons and store locations. When a user taps their SPR to a RNID NFC tag, the PAS may access any or specific data obtainable about the associated tagged item. The PAS may append to the PDB such obtained data for future reference or action by the user. Associated data could also be included in the PDB, such as names of salespersons who sold item to the user. This can be accomplished by tapping the SPR to the tag of a bought item and go into a verbal input data capture mode where the user may inform the PAS, for example, “Shorty is the name of the salesman who sold me my new car”. Later, if the customer needs to call Shorty for a question about the new car, PAS is put into command mode, and the user commands “call Shorty”. PAS queries the PDB for “Shorty”, retrieves the RNID associated with “Shorty”, and retrieves all the other information associated with that RNID, which may include the dealer the car was bought from, the full name of the salesperson who sold the car, and his phone number. Then the PAS will place the call to that phone number and ask to speak to “Shorty”. All of this accomplished through the item RNID and the database tree within the PDB.

In embodiments, other actions and decision making with the PDB can be accomplished with software tools, such as IFTTT (If This Then That), the web-based service that allows uses to create their own chains of simple conditional statements, called “recipes”, which are triggered based on changes to other web services such as Gmail, Facebook, Instagram, and Pinterest, all accomplished with simple look-ups of RNID's in the PDB. By sharing “logic” with others for a user-driven IFTTT “like” functionality, the logic data database will be driven by consumer choices and desires, and will become a huge knowledge database of value for many other applications.

In embodiments, other software tools and phone apps could provide directions to the user to a particular store for the purchase a desired item. The user may instruct their PAS to find the nearest stores for a particular-appliance or item. The PAS may use store locations obtained above to select the nearest ones based on the GPS coordinates of the SPR. A mapping app on the SPR may be used to display driving instructions to the user.

In embodiments, the PDB will build up a history of personal shopping habits, such as but not limited to stores frequented, times of day, amounts spent on specific food groups, coupons used, what credit cards used, loyalty cards, etc. This database is “owned” by the ARIND, which protects the privacy of the user and the security of the contents. The user can interface the PDB through the PAS. For example, the customer could ask the PAS “when and where did I buy my jeans, and what credit card did I use, and the PAS will query the PDB with ARIND access to provide the answers. The PAS can also mediate targeted advertising to the ARIND. At the user's discretion and direction, the PAS will direct such advertising to the SPR display, the user's computer, tablet, text messaging, or any other media owned by the user. This ultimately enables businesses new strategies for information item delivery to the electronic communication media chosen by the user.

In embodiments, the PDB will reside in a secure cloud database. When the PAS and ARNID are downloaded, the user could be asked to enroll in a PDB data protection plan by using the SPR's camera and finger print detection system to capture both facial and fingerprint images for storage in the secure PDB database as well as the ARNID. See FIG. 25. If a user's SPR is lost or destroyed and is replaced with a new SPR, when the PAS is downloaded a menu screen could be displayed asking the user “is this a replacement phone?” A yes answer may prompt the user to put their fingertips on the finger print scanner and take “selfies” of their faces. These images will be sent to the secure database for matching to the stored ARNID, which will then be downloaded to the new phone, restoring user access to his/her PDB.

In embodiments, if a SPR RNID NFC tag is attached to the SPR's packaging somewhere, and the phone is first powered up, a screen message could prompt the user to tap the SPR to that tag, and the RNID will be stored in the phone's memory. When the PAS and ARNID is downloaded for a first time, the SPR's RNID will be retrieved from memory, and it will then be sent to the secure database to establish the customer's PDB with the cell phone RNID now part of the “credentials” along with the ARNID for the PAS to access the data base. So, with above scenario for a lost or destroyed SPR, the new SPR RNID will replace that of the lost or destroyed SPR for PDB access by the PAS and the RNID of the lost or stolen SPR will no longer achieve access to the PDB. When the cell phone's RNID is used along with the ARNID for PDB access or other credentialing, it will be noted as ARNID/RNID.

In embodiments, when a user purchases an NFC tagged item, the tag could be read by a Point of Sale (POS) checkout NFC reader system, which moves the item into a purchased state in the database that associates the ARNID/RNID with the item RNID or barcode. This action will occur in the store database, the SDB, and the CDB. This information could be used for item returns and repair, or other actions where the item integrity, authenticity can be quickly verified as being legitimately owned by the user through the ARNID/RNID by reading the tag and retrieving the purchased information from the database while not disclosing user private information. Thus, the system through the combination of ARNID/RNID, PAS/RAPP becomes self-authenticating for applications like the Federal Rules of Evidence “Chain-Of Custody” ownership. The manufacture of the item item will use this information to know the ARNID that purchased the item to be able to push advertising to.

In embodiments, if the purchased item is bought at a store, but is delivered from the store warehouse or distribution center (DC), such as for large appliances, the RNID NFC tag attached to the item will not be accessible, so there will be no NFC tag to read at checkout to move the item into the purchased state. The item will be moved into the “purchased and delivered” state upon delivery where the delivery is confirmed in some manner There are many ways to achieve this, all of which fall under the scope of the embodiments disclosed herein.

In embodiments, one way is at the time of purchase at checkout, an electronic receipt containing the item barcode, (associated with a specific NFC tag RNID in the warehouse) information is sent to the purchaser's PAS which acknowledges receipt by sending its ARIND/RNID to the store's DB. It stores the item barcode information in its PDB for later retrieval. In both the store's database and the PDB the item is entered-into-the “purchased but not delivered” status. When the item is delivered, the customer taps his/her SPR to the NFC RNID tag attached to the item, which the PAS sends to the SDB, where the tag RNID is used to access the CDB and retrieve the item barcode. If this matches that stored in the PDB, then the PAS sends its ARIND/RNID to the store's DB, and upon matching that which was previously sent, confirms delivery of the right item to the right person. In both the store's DB and PDB the item status is changed to “purchased and delivered” and the date of delivery is inserted. This action is also reflected in the SDB and CDB.

In embodiments, in this manner, every item having an NFC RNID tag must leave a store or warehouse by a legitimate means moving into a “purchased” state or it can't be returned, repaired, or replaced by the wholesaler or retailer. This may eliminate any monetary gain from theft.

In an embodiment, a customer could interact with any NFC tagged item after purchase. By way of example only, the following scenarios are provided and are not meant to be construed in a limiting sense:

In embodiments, improved applications for a wireless technology in the supply chain application can be achieved by incorporating nested smart tags, wherein groups of items such as cases, pallets, or truckloads are associated with one “wireless tag” that provides information about smaller groupings of items or individual items and their associated tags. For example, a case of tagged items can have a laser programmed NFC tag on the case that can provide information about individual units within the case. The NFC tag may contain a random laser programmed (Read Only Memory) ROM code that may point to a greater database with previously scanned information for each of the units (e.g., scanned when the units were assembled into the case, or before collection). A pallet of such cases (say, 12 cases) can be provided with a higher-level tag that contains or points to information for each of those tags for the cases. Thus, information for each case could be retrieved by scanning the single tag for the pallet, and information for each of the units in any of the cases can be obtained once the code for the case is scanned or known from reading the pallet tag. Depicted is a pallet containing multiple cartons, each of which contains multiple item packages. Each item package has an NFC label, as does each carton and the pallet itself. The case NFC tags provide information about the enclosed packages, and the pallet tag provides information about each of the case tags.

In embodiments, NFC ROM can be used to track items grouped in various hierarchies: (1) individual items or single packages containing multiple items for consumer purchase; (2) cartons or cases of multiple items; (3) pallets of multiple cartons or cases; and (4) loads (e.g., truckloads, shiploads, or railcar loads) of multiple pallets. The items at each of these levels may be assigned a NFC ROM tag that is associated with information pertaining to at least one adjacent hierarchical level. For example, an NFC Tag/label on a pallet may be associated in a database with the NFC Tag/labels for each carton on the pallet, or may be associated with data pertaining to the ROM NFC Tag/Label from the truckload.

In embodiments, the concept of nested or “cascading” RFID systems can be extended even further, or offered in other combinations. In the following paragraphs, we provide additional variations that might be of benefit to the supply chain and other applications by using ROM NFC tags and using NFC smartphones to read them.

In embodiments, a NFC RNID tag reader “Smartphone” downloads an authorized Project Assistant Nesting Software (PANS). PANS also is accompanied by an ARNID. The “smartphone” simply activates its PANS which then sets the Smartphone to a “nest tags” mode.

In embodiments, as items are placed in a first package or box, the PANS then reads the TRNIDS and the TRNIDS are then placed in the SDB in a “ready to nest” mode as 1 TRNIDs, where the numeral “1” refers to the first nesting level.

In embodiments, when the package or container is sealed, a verbal or keyboard command is given to the PANS “next level” and a TRNID is placed on the first package or container, and it too is read by the PANS enabled reader. It is now designated in the SDB as a 2 TRNID and is then linked to the 1 TRNIDs in the SDB, where the numeral “2” refers to the second nesting level.

In embodiments, when these packages or containers are placed into second shipping boxes or containers, their 2 TRNIDs are read by a PANS enabled reader and then are placed into the SDB in “ready to nest” mode.

In embodiments, when the shipping box is sealed, a verbal or keyboard command is given to the PANS “next level” and a TRNID is placed on it, and is then read by the PANS enabled Smartphone reader. It is now designated in the SDB as a 3 TRNID and is linked to the 2 TRNIDs in the SDB, where the numeral 3 refers to the third nesting level.

In embodiments, when the shipping boxes are then loaded onto a truck for delivery, the PANS enabled Smartphone reader reads the 3 TRNIDs, which are placed into the SDB in “ready to nest” mode.

In embodiments, when the boxes are finally loaded, a verbal or keyboard command is given to the PANS “next level” and a TRNID tag is placed somewhere on or in the truck, or onto a shipping manifest, and read by the PANS enabled Smartphone. It is now designated as a 4 TRNID in the SDB and is then linked to the 3 TRNIDs in the SDB. The numeral 4 designates the fourth nesting level.

In embodiments, at any time, during or at delivery, the entire contents of the truck can be known by placing the PANS enabled Smartphone reader into “nest discovery” mode and reading the 4 TRNID tag. The 4 TRNID is sent to the SDB which links to the 3 TRNIDs which link to the 2 TRNIDs which link to the 1 TRNIDs which link to the item data information for each of the 1 TRNIDs, and the item information is read out for every item in the truck.

In embodiments, this process can be furthered iterated by the PANS on SEA containers which might have a truck within it confines. Following the process above, their TRNIDs may be designated a 5 TRNID in the SDB and may be linked to the 4 TRNIDs.

In embodiments, the PANS could be part of PAS functionality for household or retail use where items could be nested using sheets of RNID tags purchased at the local office store.

In embodiments, all variations on these concepts are included in this application.

In embodiments, any application that involves the PAS obtaining and gleaning specific item information from an NFC RNID tag to be stored in the PDB is included in this application by reference. Also, any application, where any reader of any kind is reading a RNID label of any kind, be it printed, or with any RFID tag, is included in this application by reference. Also, the concept of a random number label or tag can be expanded to include any representation of randomness with anything optical, such as with symbols and images, and electrical, acoustics, chemistry, etc. is incorporated in this application by reference. Also covered is any ID that in part or whole is a random number, where the definition of random number includes any number that is not repeated in the use space or predictable from a collection. The NFC RNID reader could be a NFC read-enabled smart home item, manufacturing device, or other ‘smart’ device, appliance, or apparatus, incorporating the NFC reading technology.

In embodiments, any application that involves the PAS obtaining and gleaning specific item information from an NFC RNID tag to be stored in the personal database may be enabled. Also, any application, where any reader of any kind is reading a RNID label of any kind, be it printed, or with any RFID tag, may be enabled. In additional embodiments, a random number label or tag may include any representation of randomness with anything optical, such as with symbols and images, and electrical, acoustics, chemistry, etc. In an embodiments, the RNID may include an ID that in part or whole is a random number, where the definition of random number includes any number that is not repeated in the use space or predictable from a collection. In an embodiment, the NFC RNID reader could be a NFC read-enabled smart home item, manufacturing device, or other ‘smart’ device, appliance, or apparatus, incorporating the NFC reading technology. Herein follows a more detailed explanation.

In an embodiment, before any grocery item is used and discarded the user reads the tag on it, the wrapper, or container with his/her smart phone reader (SPR). The personal assistant software (PAS) sends the RNID to the producer's database to retrieve the barcode, then uses the barcode to access other data bases for the item information. The PAS then puts the retrieved item descriptions into a shopping list in the personal database (PDB). When it is time to go to the grocery store the PAS could send an electronic note or reminder to the user. When shopping, the consumer may bring up the list on the SPR display screen.

In another embodiment, the SPR includes a barcode reader app which reads the barcodes directly versus retrieving them as the above.

In an embodiment, a user taps their SPR to an NFC tagged sensor, such as a thermostat, for example, that the user has bought and installed in his/her house. The PAS uses the tag data to access databases to retrieve item information, such as the instruction manual on how to interact with the sensor, either manually or remotely.

In an embodiment, when a databased item is sold to another company, corporation, business or person the item could be transferred to the new owner's personal database along with all relevant data that was tagged to the item or items. The store item database (SDB) (e.g., retailer database), customer database (CDB) (e.g., manufacturer database), and store database where the item was purchase will be changed to reflect new ownership. This action needs to be done in a secure fashion to avoid fraudulent transfer. The PAS of both seller and purchaser could communicate with each other to transfer item ownership by changing the application RNID (ARNID) of the previous owner to the new owner in the PDBs, the SDB, the CDB, and the store's database where the item was sold. The current owner will tap their SPR to the RNID NFC tag and tell the PAS to transfer ownership of that item. The PAS will ask for both fingerprint and facial recognition authentication. Once obtained, the PAS will place the item tag RNID in a ready to transfer status. The new owner's PAS will be notified that the ownership transaction has been approved, and ask for fingerprint and facial recognition authentication of the new owner. Once obtained, the PAS will tell the new owner to tap the RNID NFC tag to verify that the right item is identified, and then transfer its ARNID to the item RNID in all relevant databases, the store database where the item was purchased, the SDB, the CDB, and the PDB's.

In an embodiment, if a private individual, retailer or small business desired to apply a barcode enabled NFC RNID tag label to any item or item that did not already have a pre-existing NFC tag and barcode label, they could create one themselves through the PAS by the following process: An individual may by either voice command or keypad input tell the PAS to create a barcode label. The PAS may pull up a barcode creation app, and the user may fill in the input fields that describe the item or item to be tagged. After completion, the PAS may then send that information out to either any authorized/approved local or remote printer/facility that has barcode label feedstock with authorized embedded NFC RNID tags. For example, the printer could be located at an office supply store, and may print the labels to be picked up by the authorized authenticated customer. Or such printer could be located on site at a retail store for labeling items that did not have pre-existing labels. Or it may be located at a remote site and the printed labels shipped. Such capabilities could be useful, for example, when a household is packing for a move to another location and, upon unpacking wants or needs to track and locate boxes by specific item level, or for selling items to others, such as directly or through services like eBay. Also, it will be useful to retailers, like brick-and-mortar stores as well as Internet sales entities, such as Amazon.com, who may want to start using NFC tags before they are widely available for all the benefits they provide both to resellers and new and existing customers.

In an embodiment, NFC RNID tags are produced and attached to 8.5×11 sheets of stock (any size could be used). These sheets are sold through outlets like Walmart, Best Buy, or other stores. They can be purchased by the consumer to attach to any item in their home, or items they wish to sell via eBay or Amazon. Once attached, the consumer reads the tag with their SPR, which sends the tag RNID and ARNID to the secure RNID database, which sends a response back to the PAS asking for an item description or barcode. The user can either (or both) dictate to the PAS or write a description through the SPR keyboard for the newly tagged item, or pull up the barcode reader app to read the barcode attached to the item. Once inputted, this tag is now “registered” in the secure RNID database with the item NFC tag RNID, the ARNID, and the item barcode and/or description. Upon attaching and registering the labels to that user PAS ARNID and user item, uniqueness has been assigned to that item. This uniqueness can be used for any (and more) of the above identified scenarios and use cases.

In an embodiment, if retailers desire to create new NFC tags for items that have only barcode tags, they may read the existing barcodes with a handheld hybrid NFC barcode reader, which may then transmit that data to an NFC RNID feedstock printer, which may then print a new barcode label with the new embedded NFC tag RNID, to be applied adjacent to or over the pre-existing barcode label.

Further description of ways the PAS can interact with the NFC RNID tagged items and items is provided in the following scenarios that show examples of what can be achieved with this unique, new capability. These scenarios are provided by way of example only, are not exhaustive, and any other scenarios that can be imagined with this approach are within the scope of the present application.

In an embodiment, when a user reads a NFC RNID tag with their SPR, the tag RNID is sent along with the ARNID to the SDB, where the CDB is accessed with the manufacture's access information associated with the RNID. In exchange for the CDB providing item information associated with the RNID stored in CDB, the ARNID is provided to the CDB, which stores it along with the RNID, and time and day of query. Over time with a customer reading NFC RNID tags on a variety of items, and purchasing tagged item, the CDBs of the manufacturers of the tagged items build up a shopping history for the person's ARNID, which the manufacturers can use to push customer-specific advertising out to the customer's ARNID. The advertising is sent through the SDB along with the customer's ARNID, which associates user SPR contact information with the ARNID to send the advertising on to the SPR for display. A fee can be charged to the manufacturer by the SDB for this transaction. This process allows advertising to be pushed to a consumer without exposing any consumer personal or direct contact information to the manufacture.

In another embodiment, with the PAS having its own website address where information and advertising is sent to. The PAS then serves as a cloud DBS surrogate entity for the user for all Internet interactions. The user instructs or interacts with the PAS via whatever means of user choice, including texting, voice key board input, touch screen input on whatever device of user choice, including cell phone, smart phone, computer, tablet, etc. The user may “log on” to their PAS DBS surrogate via secure means, such as by way of a password or biometric input, including smart phones with an unlock code or fingerprint verification, or by facial recognition, or any means to authenticate the user. The PAS DBS surrogate may operate from the SDB to interact with websites and cloud based apps with its identity for the delivery of information and services, which are then sent to the user via delivery of user choice. Only the PAS identity may be exposed to the “outside” world, protecting the privacy of the user. Internet and platform providers may then send marketing and advertising to the PAS based on its Internet activity. Distribution of the advertising is by instructions to the PAS from the user. For example, the user could instruct the PAS that he/she wants to see such advertising directly on the SPR display, or through messaging, or by email, or verbally. If the user is in the market to buy a particular-item, it could instruct the PAS to send only those advertisements relating to that particularly item through for display or alert. The user could have a friends group, where the user could instruct the PAS to send advertisements relating to certain areas along to all the members of the group. Also, the user could instruct the PAS what advertising not to forward, and just trash. In this way, the user customizes what advertising he/she wants to know about and how and what means it is presented.

In an embodiment, the PAS could also “pull” advertisements by instruction from the user to seek ads relating to a particular-item the user is interested in buying. The CDBs may facilitate such a capability by establishing access through ARNIDs. When an ARNID “token” is given to a CDB in exchange for item information, that ARNID could be put into a CDB access file as an authorized ARNID to request data from the CDB. When the CDB provides item data to an ARNID, it could also provide a website address for the PAS to access with its ARNID credentials. When a user is looking for an item or appliance, such as a new oven, he/she can instruct the PAS to look for “special deals”. The PAS will access all the CDBs with its ARNID access credentials, and seek item information, including special sales and discount coupons, as well consumer reviews, etc. The PAS will screen and send the relevant data to the display option chosen by the user.

In an embodiment, where during-the-course of the PAS going through the SDB for interfacing with the Internet, websites, databases, and using smart phone apps for the delivery of information and services (such as for weather forecasts or pizza ordering and delivery) to the PAS ARNID as the surrogate for the user, the PAS ARNID is retained by information and service providers for-the-purpose of targeted marketing to the PAS, such as with the CDB's in scenario 8. No user personal information is revealed or exposed in such transactions, protecting the user privacy. The advertising is sent through the SDB along with the customer's ARNID, which associates user SPR contact information with the ARNID to send the advertising on to the SPR for display. A fee can be charged to the sender by the SDB for this transaction. This process allows advertising to be pushed to a consumer from any source without exposing any consumer personal or direct contact information to the sender, thereby protecting the consumer's privacy.

In an embodiment, when the PAS uses the phone apps for the delivery of information and services as the user surrogate for protecting the privacy of the user, it sends the app contact information to the SDB along with its PAS ARNID, and it is the SDB that then contacts the apps, not the PAS. This basically puts a firewall between the PAS and the apps. The app request is sent to the app from the SDB along with the PAS ARNID as the app requesting entity. If the app so desires it can retain the PAS ARNID and the SDB contact information to later send targeted advertising to. The app has no information on either the user or how to contact the PAS ARNID directly. The app responds back to the SDB with the requested information or services along with the PAS ARNID. The SDB then relays that information on to the PAS using its ARNID to look up the contact information in the SDB associated with that ARNID.

In an embodiment, an 18-pound turkey is ready to cook in a person's new oven, but she doesn't know how to cook it. So, she reads the NFC RNID tag attached to the new oven with her SPR and the PAS accesses her PDB with the RNID to retrieve all the oven item information that was appended to the PDB upon oven purchase. If this information was not added at the time of purchase, the RNID is sent to the SDB, then on to the oven's manufacturer database, where the item data is retrieved by the PAS and then added to the PDB. The PAS then asks, “What would you like to know about your new oven?” The customer could simply touch the turkey's NFC RNID tag with the SPR and the PAS could put the items together and ask “would you like to cook this turkey?” Or she could ask the PAS “How do I cook this 18-pound turkey?” Note that this is not simply any 18-pound turkey, but the “Butter Ball” Turkey processed on a particular-date, at a particular-plant with full knowledge of the food, and producer, plus the typical fat content. With this specific information, the PAS accesses a phone app that provides the ambient temperature of the surrounding area, altitude, and humidity, all factors in roasting the perfect turkey. In addition, because the PAS has full knowledge of what is in the consumer's pantry and refrigerator, and knows, by the date that it is Thanksgiving, additional menu options are also presented to her. The PAS then goes to the oven's operational manual in the PDB and comes back with “I recommend you convection roast the turkey, uncovered, for four hours at 325 degrees. You need to check internal temperature with a meat thermometer until you reach “325” degrees. The turkey should be placed on a roasting pan to collect the juices while cooking. Do you know how to set the time and temperature, or should I tell you?” The customer tells her PAS that she already knows, turns the oven to the proper settings and inserts the turkey.

In an embodiment, a user may simply ask the PAS one question; “How do I cook my turkey?” Since the PDB has everything that has ever been purchased the PAS knows already what turkey was bought, its weight, that it was frozen, as well as how they like their turkey cooked from previous PAS cooking episodes. The PAS also knows what oven had been purchased and has its instruction manual in the PDB. So, the PAS asks if she would like various recipes printed on her Bluetooth printer and out comes the instructions on how to cook the turkey (temp, time, etc.) as well as some new possible recipes. The PAS could also know what ingredients are in the pantry/house from prior purchases to tell her that she needs to go to the store and buy various items she doesn't have for a recipe.

In an embodiment, the PDB contains the data for which medications you are taking, when they need to be re-ordered, your diet, the food you are trying to avoid as well as any food allergies you may have, and what is in your pantry and refrigerator. The PAS uses this data to make recommendations for breakfast, lunch and dinner, and tells you when it is time to go to the grocery store to replenish. Also, when shopping, the PAS could inform you of any interactions of OTC NFC RNID tagged medications that interact with your prescription medications, and alert you with undesirable food interactions with psychotropic drugs and grapefruit, as well to any NFC RNID tagged food items containing allergens you are trying to avoid. The PAS will be able to inform the user of seasonal recipes for Thanksgiving, Christmas, Ramadan, Hanukah, 4th of July, etc.

In an embodiment, various corporations, companies, local government, religious organizations, local stores, etc. may be authorized for blanket broadcasting of information and advertising via local area wireless networks within towns, cities, and recreational areas and parks. Each store, construction site, recreational park, church, billboard, etc. can broadcast any event, service, or digital information for the use of mass direct marketing purposes. These marketing practices and information services could include things such as local events, functions, sales, jobs, etc. The PAS may be able to tune in to and review and screen each-and-every desired bit of data to pass on to the user what the PAS knows will be of interest or pre-filtered towards the user desires for that specific time and locale within a GPS defined area of interest. For example, if a user was driving through any town and was looking for a specific place for lunch with a cuisine, the PAS may pass the desired information to the user that a local diner is having a half price lunch special on a specific food as well as send out a coupon for that specific time and date. Or if an out of work carpenter was driving past a construction site looking for a job, the PAS may pass on to the user that the construction company was looking for carpenters and could respond to the job site with a resume and/or an on the spot interview. These local area networks may target high traffic areas so that the largest number of PAS's may be receiving and screening for the desired information that is of interest to their users. Only the desired screened data or advertising information is delivered to those that have interest providing an end-result of highly targeted marketing, advertising, and information delivered to an interested audience.

In an embodiment, when a user enters a retail store, the PAS logs onto the store's wireless network which instructs the PAS how to send item tag RNIDs to the retail store's database (RTB) to retrieve item data. This process unfolds exactly like that for the CDB's expect the RTB now retains the ARNID to push retail store advertising to.

In an embodiment, when a user enters a retail store, the PAS has stored in the PDB the GPS coordinates of favorite retail stores the consumer of PAS shops at. The store RNID accesses information to the RDBs. When the user enters such a store, the GPS coordinates identifies the store, and then sends item tag RNID to the retail store's RTB to retrieve item information. This process unfolds exactly like that for the CDB's expect the RTB now retains the ARNID to push retail store advertising to.

In an embodiment, improved applications for a wireless technology in the supply chain application can be achieved by incorporating Nested smart tags, wherein groups of items such as cases, pallets, or truckloads are associated with one “wireless tag” that provides information about smaller groupings of items or individual items and their associated tags. For example, a case of tagged items can have a laser programmed NFC tag on the case that can provide information about individual units within the case. The NFC tag may contain a random laser programmed (Read Only Memory) ROM code that may point to a greater database with previously scanned information for each of the units (e.g., scanned when the units were assembled into the case, or before collection). A pallet of such cases (say, 12 cases) can be provided with a higher-level tag that contains or points to information for each of those tags for the cases. Thus, information for each case could be retrieved by scanning the single tag for the pallet, and information for each of the units in any of the cases can be obtained once the code for the case is scanned or known from reading the pallet tag. Depicted is a pallet containing multiple cartons, each of which contains multiple item packages. Each item package has an NFC label, as does each carton and the pallet itself. The case NFC tags provide information about the enclosed packages, and the pallet tag provides information about each of the case tags.

In embodiments, NFC ROM can be used to track items grouped in various hierarchies: (1) individual items or single packages containing multiple items for consumer purchase; (2) cartons or cases of multiple items; (3) pallets of multiple cartons or cases; and (4) loads (e.g., truckloads, shiploads, or railcar loads) of multiple pallets. The items at each of these levels may be assigned a NFC ROM tag that is associated with information pertaining to at least one adjacent hierarchical level. For example, an NFC Tag/label on a pallet may be associated in a database with the NFC Tag/labels for each carton on the pallet, or may be associated with data pertaining to the ROM NFC Tag/Label from the truckload.

In embodiments, described is a method for using item assistant software (PAS) downloaded from a secure web site with a unique Application Random Number ID (ARNID) onto a NFC random number ID tag reader-enabled smart phone that serves as the authorized user interface to NFC Random Number ID (RNID tags and NFC RNID tag databases to protect the privacy of every user by using the PAS ARNID as the surrogate for the user, such that no user private information will ever be disclosed.

In embodiments, described is a method of using PAS to create and continuously update a cloud-based Personal item information Database (PDB) that is identified only by the PAS ARNID, and which contains item data obtained from the interaction of the PAS with NFC RNID'd items and item databases.

In embodiments, described is a method where the unique RNID tag is a Near Field Communication (NFC) Radio Frequency Identification (RFID) tag which is read by an RNID NFC tag read-only enabled reader where from the information obtained from the tag, which could be attached to any item, and/or from at least one database associated with the tag RNID, the Item Assistant Software (PAS) residing on the reader, or residing on a remote server or cloud and accessed via a PAS app on the Smart Phone Reader (SPR), which using information from the RNID tag read, gleans item information from potentially multiple databases, and presents the desired gleaned item information to the user in a relevant and actionable manner

In embodiments, described is a method where the NFC tag RNID read-only enabled reader is an NFC read enabled smart phone.

In embodiments, described is a method where the Item Assistant Software (PAS) functionality resides entirely within the NFC read enabled smart phone (i.e. firmware).

In embodiments, described is a method where the Item Assistant Software (PAS) functionality residing on the reader, is an “authenticated” “authorized” Reader APP (RAPP) on the NFC read enabled smart phone.

In embodiments, described is a method where the NFC tag read-only enabled reader is an NFC read enabled smart home item, control module, manufacturing device, or other ‘smart’ device, appliance, or apparatus, incorporating the NFC reading technology.

In embodiments, described is a method where the PAS functionality resides in the Cloud; a sub element of the PAS can also reside and operate independently, or enhanced by Cloud based technology, from or on the users Reader APP (RAPP).

In embodiments, described is a method where the information stored in the NFC tag is a Random Number ID (RNID) where item information, such as the item barcode, is associated with the RNID in a database or cloud database; and on retrieving the RNID from the tag read, the PAS may then send that RNID over a cellular, wireless, or any data link into the database to retrieve the barcode, and any other gleaned/data-mined item information stored in the operational, warehouse, or personal database associated with the RNID; and then it could then send the obtained barcode information to other databases to obtain further gleaned item information related to that barcode; and it could also send back a unique barcode that is assigned an RNID, wirelessly to other authorized entities; for example, a RNID barcode could be sent to an authorized monitor on an authorized network which could be then read and authenticated via an NFC read-only enabled smart phone with an RNID enabled Barcode App.

In embodiments, described is a method where the information stored in the NFC Barcode is a Random Number ID (RNID) where item information, such as the commercial item barcode, is associated with the RNID in a database or cloud database. In embodiments, described is a method where the information stored in the NFC tag is a Random ID Symbol (RIDS) where item information, such as the item barcode, is associated with the RIDS in a database; and on retrieving the RIDS from a tag read, the PAS may then send that RIDS over a cellular, wireless, or any data link into the database to retrieve the barcode, and any other gleaned/data-mined item information stored in the operational, warehouse, or personal database associated with the RIDS; and it could then send the obtained barcode information to other databases to obtain further gleaned item information related to that barcode.

In embodiments, described is a method where the tag contains the barcode information and other item information, and the PAS may then send that barcode to other databases to retrieve or glean further unique or aggregated data and/or knowledge and further item information (i.e. data mining) from that barcode.

In embodiments, described is a method of storing a unique, aggregated, gleaned data and/or knowledge item information obtained in a user Personal Database (PDB) controlled and managed by the Item Assistant Software (PAS) for later use and reference by the user; the user could also obtain more information about the item or related items with queries through the Item Assistant Software (PAS) to the tag and unique or aggregated, gleaned data and/or knowledge through operational, warehouse, item databases, and retailer databases.

In embodiments, described is a method of allowing an item assistant software (PAS) for intelligent interaction with the user to learn the likes and dislikes of the user, user item preferences, and even items to avoid for possible health and other reasons; when the user taps their reader to an NFC tag attached to an item, the tag RNID and the PAS ARNID are sent to the CDB, where the barcode and other item information associated with the tag RNID is sent back to the SDB, which then sends it to the PAS with the contact information associated with the RNID; the CDB retains the ARNID; the CDB can send an ARNID-specific advertisement to the PAS by sending the advertisement along with the PAS ARNID and the senders RNID to the SDB, which sends the advertisement and sender RNID on to the PAS with the contact information associated with the ARNID; the PAS may display such advertisement at the discretion of the user via the cell phone, smart phone, SPR, computer, text messaging, pop-up ads, or any other computer-based interface device or service; the user could then use the PAS to initiate a digital exchange handshake with the advertiser upon receiving such advertisements to alert the advertiser of the user's likes, dislikes, item preferences, and item avoidances, allowing for further tuning the advertisements sent to the user; this is accomplished by the PAS sending to the SDB its ARNID and the sender's RNID of advertisements, with the alert message; the SDB may use the sender's RNID contact information to send the alert to the CDB; the user could further initiate pull advertising through the PAS to permit and even call for advertisements in a particular-item area; the end-result is that specific item and sales information is provided to an individual via a personal device when and where it is wanted preserving the privacy of the user.

In embodiments, described is a method where a user purchases an NFC RNID tagged item, the tag could be read by a Point of Sale (POS) checkout NFC reader system, which moves the item into a purchased state in the database that associates the ARNID/RNID with the item RNID or barcode; this information could be used for item returns and repair, or other actions where the item integrity, authenticity can be quickly verified as being legitimately owned by the user through the ARNID/RNID by reading the tag and retrieving the purchased information from the database while not disclosing user private information; and thus, the system through the combination of ARNID/RNID, PAS/RAPP becomes self-authenticating for applications like the Federal Rules of Evidence such as for “Chain-Of Custody” ownership.

in embodiments, described is a method where if the purchased item is bought at a store, but is delivered from the store warehouse or distribution center (DC), such as for large appliances, the RNID NFC tag is attached to the item will not be accessible, so there will be no RNID NFC tag to read at checkout to move the item into the purchased state; the item will be moved into the “purchased and delivered” state upon delivery where the delivery is confirmed in some manner

In embodiments, described is a method where at the time of purchase at checkout, an electronic receipt containing the item barcode, (associated with a specific RNID NFC tag in the warehouse) information is sent to the purchaser's PAS, which acknowledges receipt, by sending its ARIND/RNID to the store's DB; it stores the item barcode information in its PDB for later retrieval; in both the store's database and the PDB the item is entered into-the “purchased but not delivered” status; when the item is delivered, the customer taps his/her SPR to the NFC RNID tag attached to the item, which the PAS sends to the SDB, where the tag RNID is used to access the CDB and retrieve the item barcode; if this matches that stored in the PDB, then the PAS sends its ARIND/RNID to the store's DB, and upon matching that which was previously sent, confirms delivery of the right item to the right person; in both the store's DB and PDB the item status is changed to “purchased and delivered” and the date of delivery is inserted.

In embodiments, described is a method where every item having an RNID NFC tag must leave a store or warehouse by a legitimate means moving into a “purchased” state or it can't be returned, repaired, or replaced by the wholesaler or retailer eliminating any monetary gain from theft.

In embodiments, described is a method where tagged items can be further interrogated, as the user so chooses, at any time, after purchase; the PDB could be augmented with further information about the items, such as location, downloaded manuals and instructions, etc.; the PAS, could access the PDB for information, for example, to interface with other Intelligent Personal Assistants (IPAs) or Software Agents embedded in control and sensor systems, such as for home automation, entertainment systems, home security and smart appliances.

In embodiments, described is a method where when a databased item is sold to another company, corporation, business or person the item could be transferred to the new owner's personal database along with all relevant data that was attached to the item or items; the SDB, CDB, and store database where the item was purchase will be changed to reflect new ownership; this action needs to be done in a secure fashion to avoid fraudulent transfer; the PAS of both seller and purchaser could communicate with each other to transfer item ownership by changing the ARNID/RNID of the previous owner to the new owner in the PDBs, the SDB, the CDB, and the store's database where the item was sold; the current owner will tap their SPR to the RNID NFC tag and tell the PAS to transfer ownership of that item; the PAS could ask for one or more various biometric authentication technologies such as but not limited to fingerprint and facial recognition authentication; once obtained, the PAS will place the item RNID in a ready to transfer status; the new owner's PAS will be notified that the ownership transaction has been approved, and ask for biometric data authentication of the new owner; once obtained, the PAS will tell the new owner to tap the RNID NFC tag to verify that the right item is identified, and then transfer its ARNID/RNID to the item RNID in all relevant databases, the store database where the item was purchased, the SDB, the CDB, and the PDB's.

In embodiments, described is a method where at time of manufacturing/packaging all items may be registered into a secure manufacturer database having been enabled with the capability to utilize the unique RNID NFC tag combined with the manufacturer's barcode; also, at the time of manufacturing/packaging every database associated with that device is forever linked to that specific item; as well as, but not limited to receipts, warranties, instructions, features, manuals, authorized repair people, and maybe even recipes and sales and/or manufacturer's coupons.

In embodiments, where when a user taps his or her NFC tag read-enable SPR to an NFC tag, the PAS can access all the data associated with the tagged item Through item information gleaned from RNID NFC tags and subsequently stored in the PDB, a PAS knows everything its owner has ever purchased and what is within their physical hardware, software and virtual domain, such as their refrigerator, microwave oven, stove, washer, dryer, pantry, freezer, clothing, electronics, small appliances, software, online items, etc., as well as how to interface with the PAS embedded in home electronics and control systems; it will know any medications its owners are taking, when they need to be re-ordered, it knows their diet, any food they might be trying to avoid, as well as any food allergies they might have.

In embodiments, described is a method where before any grocery item is used and discarded the user reads the RNID NFC tag on it with the SPR app from the container or wrapper; the PAS sends the RNID to a data base to retrieve the barcodes, then uses the barcodes to access other data bases for the item information; the PAS then puts the retrieved item descriptions into a shopping list in the PDB; when it is time to go to the grocery store to replenish it the PAS could send an electronic note or reminder to the user; when shopping, the consumer may bring up the list on the SPR display screen which could inform them of any interactions of RNID NFC items attached to OTC (Over the Counter) medications that might interact with any of their prescription medications, as well as alert them to any RNID NFC items attached to various food items that might contain ingredients of any food allergies they might have or are otherwise trying to avoid.

In embodiments, described is a method where before any grocery item is used and discarded the user reads the tag on it with the SPR from the container or wrapper; PAS sends the RNID NFC tagged barcode to data bases for the item information; PASE then puts the retrieved item descriptions into a “possible shopping list” in the PDB; when it is time to go to the grocery store the PAS could send an electronic note or reminder to the user; when shopping, the consumer may bring up the list on the SPR display screen when the PAS is asked for suggestions on what to cook for dinner, breakfast or lunch it could tell them what they might like to make from simply the food items currently in their PDB and informs them of various recipe suggestions.

In embodiments, described is a method where any private individual, retailer or small business desiring to apply a barcode enabled RNID entity(s) to any item(s) or item(s) that did not already have a pre-existing identification label could create one themselves through the PAS by the following process: An individual may by either voice command or keypad input tell the PAS to create a RNID barcode label; the PAS may pull up a barcode creation app, and the user may fill in the input fields that describe the item(s) or item(s) to be tagged; after completion, the PAS may translate every specific verbal or written description(s) into a barcode format and then send that information out to either an authorized/approved local home or remote printer/facility that had barcode label feedstock with authorized embedded RNID NFC tags; for an example, the printer could be located at an office supply store, which may print the labels to be picked up by the authorized authenticated customer; or such printer could be located on site within a retail store for labeling items that did not have pre-existing labels; such capabilities could be useful, for example, when a household is packing for a move to another location and, upon unpacking wants or needs to track and locate boxes by specific item level; even for applications such as selling items to others, i.e., directly or indirectly through services such as eBay; also, it will be useful to retailers, like brick-and-mortar stores as well as Internet sales entities, such as Amazon.com, who may want to start using RNID NFC tag before they are widely available for all the benefits they provide both to resellers and new and existing customers.

In embodiments, described is a method where retailers may be able to create new RNID NFC tags for items that have only barcode tags, by reading the existing barcodes with a handheld hybrid RNID NFC barcode reader, which may then transmit that specific data to an RNID NFC tag label feedstock printer, which may then print a new barcode label with the embedded RNID NFC tag to be applied adjacent to or over the pre-existing barcode label.

In embodiments, described is a method where targeted marketing and advertising is sent to the PASE ARNID without knowing or disclosing personal information, protecting the privacy of the user.

In embodiments, described is a method where when a user reads a RNID NFC tag with their SPR, the tag RNID is sent along with the ARNID to the SDB, where the CDB is accessed with the manufacture's access information associated with the RNID; in exchange for the CDB providing item information associated with the RNID stored in CDB, the ARNID is provided to the CDB, which stores it along with the RNID, and time and day of query. Over time with a customer reading RNID NFC tags on a variety of items, and purchasing tagged item, the CDBs of the manufacturers of the tagged items build up a shopping history for the person's ARNID, which the manufacturers can use to push customer-specific advertising out to the customer's ARNID; the advertising is sent through the SDB along with the customer's ARNID, which associates user SPR contact information with the ARNID to send the advertising on to the SPR for display; a fee can be charged to the manufacturer by the SDB for this transaction; this process allows advertising to be pushed to a consumer without exposing any consumer personal or direct contact information to the manufacture.

In embodiments, described is a method with the PAS having its own website address where information and advertising is sent to; the PAS then serves as a cloud DBS surrogate entity for the user for all Internet interactions; the user instructs or interacts with the PAS via whatever means of user choice, including texting, voice key board input, touch screen input on whatever device of user choice, including cell phone, smart phone, computer, tablet, etc.; the user may “log on” to their PAS DBS surrogate via secure means, such as by way of a password or biometric input, including smart phones with an unlock code or biometric such as a fingerprint or facial recognition, or by any other means that could authenticate the user; the PAS DBS surrogate may operate from the SDB to interact with websites and cloud based apps with its identity for the delivery of information and services, which are then sent to the user via delivery of user choice; only the PAS identity may be exposed to the “outside” world, protecting the privacy of the user; internet and platform provides may then send marketing and advertising to the PAS based on its Internet activity; distribution of the advertising is by instructions to the PAS from the user; for example, the user could instruct the PAS that he/she wants to see such advertising directly on the SPR display, or through messaging, or by email, or verbally; if the user is in the market to buy a particular-item, it could instruct the PAS to send only those advertisements relating to that particularly item through for display or alert; the user could have a friends group, where the user could instruct the PAS to send advertisements relating to certain areas along to all the members of the group; also, the user could instruct the PAS what advertising not to forward, and just trash; in this way, the user customizes what advertising he/she wants to know about and how and what means it is presented.

In embodiments, described is a method where during-the-course of the PAS going through the SDB for interfacing with the Internet, websites, databases, and using smart phone apps for the delivery of information and services (such as for weather forecasts or pizza ordering and delivery) to the PAS ARNID as the surrogate for the user, the PAS ARNID is retained by information and service providers for-the-purpose of targeted marketing to the PAS; no user personal information is revealed or exposed in such transactions, protecting the user privacy; the advertising is sent through the SDB along with the customer's ARNID, which associates user SPR contact information with the ARNID to send the advertising on to the SPR for display; a fee can be charged to the sender by the SDB for this transaction; this process allows advertising to be pushed to a consumer from any source without exposing any consumer personal or direct contact information to the sender, thereby protecting the consumer's privacy.

In embodiments, described is a method where when the PAS uses the phone apps for the delivery of information and services as the user surrogate for protecting the privacy of the user, it sends the app contact information to the SDB along with its PAS ARNID, and it is the SDB that then contacts the apps, not the PAS; this basically puts a firewall between the PAS and the apps; the app request is sent to the app from the SDB along with the PAS ARNID as the app requesting entity; if the app so desires it can retain the PAS ARNID and the SDB contact information to later send targeted advertising to; the app has no information on either the user or how to contact the PAS ARNID directly; the app responds back to the SDB with the requested information or services along with the PAS ARNID; the SDB then relays that information on to the PAS using its ARNID to look up the contact information in the SDB associated with that ARNID.

In embodiments, described is a method where various corporations, companies, local government, religious organizations, local stores, etc. may be authorized for blanket broadcasting of information and advertising via local area wireless networks within towns, cities, and recreational areas and parks; each store, construction site, recreational park, church, billboard, etc. can broadcast any event, service, or digital information for the use of mass direct marketing purposes; these marketing practices and information services could include things such as local events, functions, sales, jobs, etc.; the PAS may be able to tune in to and review and screen each and every desired bit of data to pass on to the user what the PAS knows will be of interest or pre-filtered towards the user desires for that specific time and locale within a GPS defined area of interest; for example, if a user was driving through any town and was looking for a specific place for lunch with a particular cuisine, the PAS may pass the desired information to the user that a local diner is having a half price lunch special on a specific food as well as send out a coupon for that specific time and date; or if an out of work carpenter was driving past a construction site looking for a job, the PAS may pass on to the user that the construction company was looking for carpenters and could respond to the job site with a resume and/or a on the spot interview; these local area networks may target high traffic areas so that the largest number of PAS's may be receiving and screening for the desired information that is of interest to their users; only the desired screened data or advertising information is delivered to those that have interest providing the end result of highly targeted marketing, advertising, and information delivered to an interested audience.

In embodiments, where any application that involves the PAS obtaining and gleaning specific item information from an NFC RNID tag and stored in the PDB is by inference includes any RFID tag used with any radio frequency; also, any application, where any reader entity reading a RNID entity of any kind, be it a chip, electronic printed chip structure either attached or connected to any substrate that has a printed, etched or other manufacturing techniques used to produce antennas which then could be singulated to provide for individual tag labels that may be attached to any packaging or item; the chips could also be attached to any stock materials that could be used for source tagging, such as the stock used to form boxes or wrappings for item, that has the antenna integral to that substrate; so, the definition of a tag entity is either a tag label or a source tag incorporated on or into the item or item packaging material be it RFID or NFC tags, is incorporated in this application by reference; also, the concepts of a random number label or tag can be expanded to include any representation of randomness with anything optical, such as with symbols and images, and electrical, acoustics, chemistry, etc. is incorporated in this application by reference; also covered is any ID that in part or whole is a random number, where the definition of random number includes any number that is not repeated in the use space or predictable from a collection; the NFC RNID reader could be a NFC read-enabled smart home item, manufacturing device, or other ‘smart’ device, appliance, or apparatus, incorporating the NFC or RFID reading technology.

In embodiments, described is a method where when a user enters a retail store, the PAS logs onto the store's wireless network which instructs the PAS how to send item tag RNIDs to the retail store's database (RTB) to retrieve item data; this process unfolds exactly like that for the CDB's expect the RTB now retains the ARNID to push retail store advertising to.

In embodiments, described is a method where the PAS has stored in the PDB the GPS coordinates of favorite retail stores the consumer shops at and the store RNID access information to the RDBs. When the user enters such a store, the GPS coordinates identifies the store, and then sends item tag RNID to the retail store's RTB to retrieve item information.

In embodiments, described is a method of nesting RNIDs in the SDB by using a PANS that reads RNIDs at different levels of packaging and provide for links for each level of nesting in the SDB to the previous RNIDs.

In embodiments, described is a method where all specific CDB, SDB, PDB, PAS, as well as all other technologies identified in this application could be in part or in total IFTTT compatible.

Another embodiment is provided as follows, as an example operation of application 116. As described above (e.g., flowchart 240 of FIG. 2C), application 116 (“app”) may be installed in computing device 104 by the secure database (SDB). The app is downloaded with a unique random number app ID (ARNID)

An API is loaded by application 116 to communicate with the SDB (identifier server 106).

The SDB is transmitted device (e.g., smart phone) communication information so that the SDB can communicate with application 116 at computing device 104. This communication information is associated with the app ARNID in the SDB.

Once installed as per above, a splash screen may be shown to the user with instructions on using application 116 to read NFC tags to get product information and that the app can be activated by any suitable mechanism, including:

a) Voice, such as the command “read tags”, at which point the app will ask the user to speak a command word or phrase to activate the app, or

b) Pulling up the app and hit the “read tags” button.

Instructions may be presented by application 116 for the user to enroll biometric identification the app will use to authenticate that the proper user is using the app. The app will instruct the user for various poses for camera shots, and for fingerprint capture. At this point the app is ready to be used. Instructions may be displayed for the user to tap computing device 104 to a store “bulls eye” tag on entering a participating retail store (retailer). The SDB uses the retailer tag identifier to identify and route TRNIDs to the store's RDB as well as to the manufacturers MDB.

When the user is ready to use the app to read NFC tags, the reader turns on the app by either a or b above, which puts the app into tag detection mode by sending a low power reader signal from the phone.

A message will then be displayed instructing the user to “tap” the phone to a NFC tag to obtain product information.

Another message will be displayed by the app on the screen of computing device 104 asking “do you want to see this message again?

If not, hit the NO button. If yes, hit the YES button You can also reactivate this message in an options menu.

On entering a retail store, the user taps the store's “bulls eye” tag. In this manner, the app retrieves the store's SRNID and sends it to the SDB. Store information may then be received from the retailer server and presented on the screen and along with sales incentives specific to the user.

When the user “taps” computing device 104 to a nearby NFC product tag (within about 2″ or less), computing device 104 detects the NFC tag, and reads the (e.g., laser programed) tag random number ID (TRNID).

After extracting unambiguously the TRNID, the app connects with the SDB and sends the TRNID along with its ARNID to the SDB.

The SDB sends to application 116 product information relating to the TRNID, along with price and any sales information or coupons from both the product manufacturer and the retail store (e.g., as described elsewhere herein). This product information is displayed on the screen.

Instructions may be presented on the screen by application 116 for the user to enroll biometric identification the app will use to authenticate that the proper user is using the app. The app may instruct the user for various poses for camera shots, and for fingerprint capture. At this point the app is ready to be used. Finally, instructions may be displayed for the user to tap the phone to a store “bulls eye” tag on entering a participating retail store to obtain the random number retailer identifier of the retailer. SDB may use this to route TRNIDs to the store's RDB as well as to the manufacturer's MDB.

At this point, the user has several options, such as:

a) “OK” button or verbal, meaning do nothing, simply move on and tap another tag.

b) Ask for more information with the command “more information”, at which point the app may ask the user what kind of additional information is desired. The user, for example, could then respond with something like “consumer report ratings of this product.”

c) Instruct (e.g., via voice, a GUI, etc.) the app to buy the product, which may have multiple future incarnations. The app may optionally move the product into a purchased category in the app's personal user database (PDB) located either on the phone or in the cloud, along with the product information, and date and place of purchase. The product may be paid for at checkout. Payment options may be set up and integrated in application 116 for paying for the product/item in real-time. Such payment options may be proprietary, or may be commercially available, such as Apple Pay®, PayPal®, an electronic currency such as a cryptocurrency (e.g., Bitcoin, Litecoin, Namecoin, etc.), etc.

After purchase, the user can continue to interact with the product NFC tag through the information stored in the PDB, such as by tapping the tag and having the app ask, “what do you want to know about this product?” The user could respond by providing these sample inquiries to application 116:

a) When and where did I buy this pair of jeans?

b) How do I cook this turkey?

At any time or location, push ads may be provided through the app from the SDB, displayed on the screen of computing device 104, as described elsewhere herein. The user can respond to such ads by instructing the app as in the following examples:

a) I am not interested in this product, so don't show me any more ads for it. As a result, the app does not display future push ads for this product.

b) Buy this product. This command may be enabled by the integration of purchasing capability into the app.

c) Show me more information about this product, at which point the app/user dialog proceeds as with b) above.

The user, at any time or place, may ask the app to display any ads or sales for a particular product of interest. The app sends this request to the SDB, which sends the app any information regarding this request, for display on the phone screen, such as described elsewhere herein.

Still another embodiment is provided as follows, as another example operation of application 116. A retail stores enroll as an RNID client with the SDB. The client is provided by the SDB with a physical poster or other display item that incorporates an RFID tag in the center, which may be fashioned as a bulls eye or have other display characteristic to attract the attention of shoppers at the retailer when they arrive at the store. The RNID of the poster is specific to that retail store (SRNID) with the store's contact and other information associated with it in the SDB.

When the customer enters the retailer, they may tap the poster tag to retrieve the SRNID. The app may send the SRNID along with its ARNID to the SDB, and the SDB may temporarily attach the SRNID to the ARNID in the SDB. When a TRNID is sent with an ARNID from the app to the SDB, the SDB may use the SRNID associated with the ARNID to send the TRNID and ARNID to the store's data base. It may retrieve store-specific information, such as sales coupons, as well as the product information from that specific manufacturer's data base.

The retail store, similar as to the manufacturer MDB, may retrain the ARNID along with the TRNID in its RDB.

The RDP builds interest data from that ARNID to send out push advertising for local sales.

When the SDB attaches the SRNID to the ARNID, it may, at this point or other, send the ARNID to the RDB. At which point the RDP could send out store information specific to that ARNID if the ARNID is already in the data base. If not within the database they could send out welcoming information to a new customer. This may be accomplished by the RDP sending this specific store information to the SDB with the ARNID, and the SDB could deliver that information to that ARNID. In this manner, the SDB is positioned to extract transactional revenue from any or all of the transactions passing through it.

### IV. Example Computer System Implementation

Personal data server 102, computing device 104, identifier server 106, manufacturer server 108, retailer server 110, application 116, any of the components of identifier server 106, manufacturer server 108, and application 116, any of the RFID tags of FIG. 6, flowchart 200, flowchart 700, flowchart 800, flowchart 900, flowchart 1000, and/or any of the components of system 1100 of FIG. 11 may be implemented in hardware, or hardware combined with software and/or firmware, including being implemented as computer program code/instructions configured to be executed in one or more processors and stored in a computer readable storage medium, as hardware logic/electrical circuitry, being implemented together in a SoC, such as an SoC that includes an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

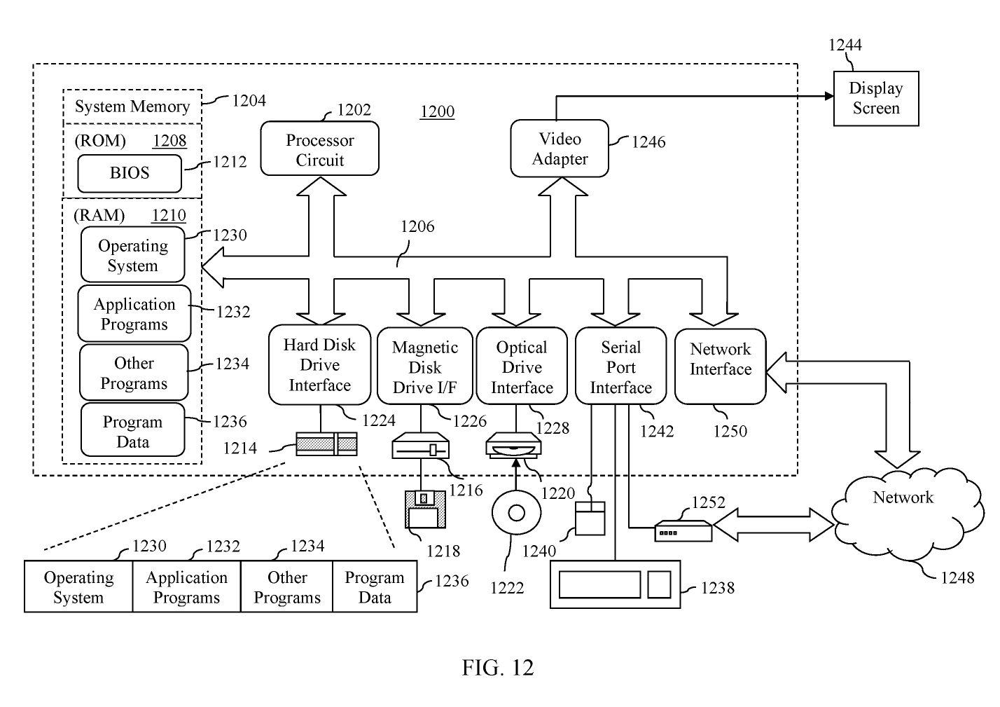

Furthermore, FIG. 12 depicts an exemplary implementation of a computing device 1200 in which embodiments may be implemented. For example, personal data server 102, computing device 104, identifier server 106, manufacturer server 108, and/or retailer server 110 may be implemented in one or more computing devices similar to computing device 1200 in mobile or stationary embodiments, including one or more features of computing device 1200 and/or alternative features. The description of computing device 1200 provided herein is provided for purposes of illustration, and is not intended to be limiting. Embodiments may be implemented in further types of computer systems, as would be known to persons skilled in the relevant art(s).

As shown in FIG. 12, computing device 1200 includes one or more processors, referred to as processor circuit 1202, a system memory 1204, and a bus 1206 that couples various system components including system memory 1204 to processor circuit 1202. Processor circuit 1202 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1202 may execute program code stored in a computer readable medium, such as program code of operating system 1230, application programs 1232, other programs 1234, etc. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computing device 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1230, one or more application programs 1232, other programs 1234, and program data 1236. Application programs 1232 or other programs 1234 may include, for example, computer program logic (e.g., computer program code or instructions) for implementing personal data server 102, computing device 104, identifier server 106, manufacturer server 108, retailer server 110, any of the components of identifier server 106 as shown in FIG. 3, any of the RFID tags of FIG. 6, flowchart 200, flowchart 700, flowchart 800, flowchart 900, flowchart 1000, and/or any of the components of system 1100 of FIG. 11 (including any suitable steps of flowchart 200, 700, 800, 900, and 1000), and/or further embodiments described herein.

A user may enter commands and information into the computing device 1200 through input devices such as keyboard 1238 and pointing device 1240. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1202 through a serial port interface 1242 that is coupled to bus 1206, but may be connected by other interfaces, such as a parallel port, game port, or a universal serial bus (USB).

A display screen 1244 is also connected to bus 1206 via an interface, such as a video adapter 1246. Display screen 1244 may be external to, or incorporated in computing device 1200. Display screen 1244 may display information, as well as being a user interface for receiving user commands and/or other information (e.g., by touch, finger gestures, virtual keyboard, etc.). In addition to display screen 1244, computing device 1200 may include other peripheral output devices (not shown) such as speakers and printers.

Computing device 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium” are used to refer to physical hardware media such as the hard disk associated with hard disk drive 1214, removable magnetic disk 1218, removable optical disk 1222, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data modulated in a data signal such as a carrier wave. The term “modulated data signal” means a signal that has one or more of its characteristics set or changed in such a manner as to encode information in the signal. Communication media embodies wireless media including acoustic, RF, infrared and other wireless media, as well as wired media. Embodiments are also directed to such communication media that are separate and non-overlapping with embodiments directed to computer-readable storage media.

As noted above, computer programs and modules (including application programs 1232 and other programs 1234) may be stored on the hard disk, magnetic disk, optical disk, ROM, RAM, or other hardware storage medium. Such computer programs may also be received via network interface 1250, serial port interface 1242, or any other interface type. Such computer programs, when executed or loaded by an application, enable computing device 1200 to implement features of embodiments discussed herein. Accordingly, such computer programs represent controllers of the computing device 1200.

Embodiments are also directed to computer program items comprising computer code or instructions stored on any computer-readable medium. Such computer program items include hard disk drives, optical disk drives, memory device packages, portable memory sticks, memory cards, and other types of physical storage hardware.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. An identifier server, comprising:
an identifier access manager configured to:
receive a random number item identifier and a random number application identifier from an application at a user device, the random number item identifier associated with an item of a plurality of items, the random number application identifier associated with the application and used in lieu of identifying information for a user of the user device to maintain privacy of the user;
authenticate the application using the random number application identifier;
determine a random number manufacturer identifier that corresponds to the random number item identifier;
transmit the random number application identifier, the random number item identifier, and the random number manufacturer identifier to the manufacturer;
receive the random number manufacturer identifier, the random number item identifier, the random number application identifier and specific item information from the manufacturer; and
transmit the random number manufacturer identifier, the random number item identifier and the specific item information to the application to enable the specific item information to be displayed on the user device.

2. The identifier server of claim 1, wherein the random number item identifier is stored in a RFID (radio frequency identification) tag associated with the item.

3. The identifier server of claim 2, further comprising:
an identifier assignor configured to
assign the random number manufacturer identifier to the manufacturer, the random number item identifier to the RFID tag, and a random number retailer identifier to a retailer of the item, and
transmit the random number manufacturer identifier, the random number item identifier, and the random number retailer identifier to the identifier repository.

4. The identifier server of claim 1, wherein the identifier access manager is further configured to:
receive, from the manufacturer, one or more advertisements and the random number application identifier; and
transmit, to the application, the one or more advertisements to be accessible by a user of the user device.

5. The identifier server of claim 1, wherein the identifier access manager is further configured to:
receive, from the application, an item request, the random number application identifier, and at least one random number manufacturer identifier associated with the item request;
for each associated random number manufacturer identifier,
transmit the random number application identifier, the random number manufacturer identifier and the item request to the manufacturer, and
receive the random number application identifier, the random number manufacturer identifier, the item request, and an advertisement associated with at least one of the item request or the manufacturer; and
transmit, to the application, the random number application identifier, the random number manufacturer identifier, the item request, and the advertisement.

6. The identifier server of claim 1, further comprising:
application software storage configured to enable the download of the application and the random number application identifier to the user device in response to a user request.

7. The identifier server of claim 6, wherein the application includes a tag reader application.

8. A manufacturer server, comprising:
a manufacturer identifier manager configured to
receive, from an identifier server, a random number item identifier, a random number application identifier, and a random number manufacturer identifier, the random number item identifier associated with an item of a plurality of items, the random number application identifier associated with the application and used in lieu of identifying information for a user of the user device to maintain privacy of the user, the random number item identifier associated with an item of a plurality of items and the random number manufacturer identifier corresponding to a manufacturer of the manufacturer server,
store, in a manufacturer identifier archive of the manufacturer server, the random number item identifier and the random number application identifier,
access, from a manufacturer item database associated with the manufacturer, specific item information associated with the received random number item identifier, and
transmit, to the identifier server, the random number manufacturer identifier, the random number item identifier, the random number application identifier and the specific item information.

9. The manufacturer server of claim 8, wherein the random number item identifier is stored in a RFID tag associated with the item.

10. The manufacturer server of claim 8, wherein the manufacturer identifier manager is further configured to:
receive, from the identifier server, a batch of random number identifiers;
allocate each random number identifier to a corresponding item of the plurality of items; and
associate, in the manufacturer item database, each random number identifier with corresponding specific item information for the corresponding item.

11. The manufacturer server of claim 10, wherein each random number identifier is stored in a RFID tag.

12. The manufacturer server of claim 8, further comprising:
a manufacturer advertisement manager configured to
determine a product preference for a user associated with the application based at least on the specific product information associated with the random number application identifier;
select one or more advertisements based on the determined product preference; and
provide the one or more advertisements, the random number application identifier and the random number manufacturer identifier for transmitting to the identifier server.

13. The manufacturer server of claim 8, further comprising:
a manufacturer advertisement manager configured to
receive an item request, the random number application identifier, and the random number manufacturer identifier from the identifier server;
determine one or more advertisements associated with the item request or the manufacturer; and
provide the one or more advertisements, the random number application identifier, the item request, and the random number manufacturer identifier for transmitting to the identifier server.

14. A computing device, comprising:
an application configured to:
receive a random number item identifier, the random number item identifier associated with an item of a plurality of items;
transmit, to an identifier server, the random number item identifier and a random number application identifier associated with the application and used in lieu of identifying information of a user of the computing device to maintain privacy of the user;
receive, from the identifier server, a random number manufacturer identifier, the random number item identifier, and specific item information associated with the item; and
display the specific item information on the user device.

15. The computing device of claim 14, wherein the random number item identifier is stored as a tag identifier in a RFID tag associated with the item, wherein said receive a random number item identifier comprises:
reading the tag identifier from the RFID tag.

16. The computing device of claim 14, wherein the application is further configured to:
receive, from the identifier server, an advertisement and the random number application identifier;
screen the advertisement for at least one of displaying or storing.

17. The computing device of claim 14, wherein the application is further configured to:
transmit, to the identifier server, an item request, the random number application identifier, and at least one associated random number manufacturer identifier associated with the item request;
receive, from the identifier server and in response to the item request, the random number application identifier, the random number manufacturer identifier, the item request, and one or more advertisements; and
screen the one or more advertisements for at least one or displaying or storing the one or more coupons or deals.

18. The computing device of claim 14, wherein the application and the random number application identifier are downloaded to the user device from the identifier server.

19. The computing device of claim 14, wherein the application is further configured to:
receive an election to create a personal database; and
receive a random number personal database identifier associated with the personal database.

20. The computing device of claim 19, wherein the application is further configured to:
transmit, to the personal database, the random number manufacturer identifier, the random number item identifier, and the specific product information.
